(19) United States
(12) Patent Application Publication
(10) Pub. No.: US 2026/0163411 A1
(43) Pub. Date: Jun. 11, 2026

(54) EMI Mitigation Features In Wireless Power Transmission Systems

(71) Applicant: NuCurrent, Inc., Chicago, IL (US)

(72) Inventors: Alberto Peralta, Chicago, IL (US); Jim Crnkovic, Chicago, IL (US); Juan Serrano, Chicago, IL (US); Michael Guido, Chicago, IL (US); Md Nazmul Alam, Glendale Heights, IL (US)

(21) Appl. No.: 18/972,431

(22) Filed: Dec. 6, 2024

(51) Int. Cl. H02J 50/12; H01F 5/00; H01F 5/04; H01F 27/36; H02J 50/00; H02J 50/70

(52) U.S. Cl. CPC H02J 50/12; H01F 5/003; H01F 5/04; H01F 27/363; H02J 50/005; H02J 50/70

(57) ABSTRACT

An antenna for a wireless power transmission system includes a coil layer and a filter layer. The coil layer includes turns, a first coil end, and a second coil end. The coil layer is electrically connected to a power conditioning system via a positive electrical node connected to the first coil end and a negative electrical node connected to the second coil end. The filter layer is positioned in a stack-up with the coil layer and includes tines each comprising a conductive material, positioned proximate to the plurality of turns, and terminating at one end. The filter layer includes a filter end that is electrically connected to a ground of the wireless transmission system, wherein the filter layer is configured to absorb an E-field emitted by the coil layer and route the absorbed E-field to the ground.

### BACKGROUND

Wireless connection systems are used in a variety of applications for the wireless transfer of electrical energy, electrical power, electromagnetic energy, and/or electrical data signals. Such wireless connection systems often use inductive wireless power transfer, which occurs when magnetic fields created by a transmitting element induce an electric field, and hence, an electric current, in a receiving element. These transmitting and receiving elements will often take the form of an antenna, such as coiled wires, and the like.

### SUMMARY

Disclosed herein is new technology for mitigating electromagnetic interference (EMI) that is produced by wireless power transfer systems.

In one aspect, a wireless power transmission system includes an antenna, a tuning system, a power conditioning system, a controller, a substrate, and a conductive plate. The substrate may be configured for mounting of one or more of the tuning system, the power conditioning system, the controller, or combinations thereof and the substrate may define a single-point grounding point, the single-point grounding point electrically connected to ground connections of each of the tuning system, the power conditioning system, and the controller. The conductive plate may be electrically connected to the single-point grounding point and electrically separated from each of the antenna, the tuning system, the power conditioning system, and the controller.

The wireless power transmission system may include various other components. For example, the wireless power transmission system may further include an electro-mechanical connector configured for electrically and mechanically connecting the single-point grounding point and the conductive plate. In a further example, the electro-mechanical connector may be an electro-mechanical screw.

In another example, the wireless power transmission system may further include one or more standoffs configured for electrically separating the conductive plate from each of the antenna, the tuning system, the power conditioning system, and the controller.

In yet another example, the wireless power transmission system may further include one or more magnets, each of the one or more magnets configured to attract an opposing magnet associated with a device, the one or more magnets having a pull force. In such an example, the conductive plate has a weight configured to offset the pull force. In a further example, the conductive plate includes one or more weight cut outs, each of the one or more cutouts configured in accordance with the weight.

In yet another example, the wireless power transmission system may further include a connector for receiving input power that is electrically connected to, at least, the power conditioning system via the substrate, wherein the single point grounding point is positioned proximate to the connector. In a further example, the connector may be a USB Type-C(USB-C) connector. In another further example, the power conditioning system may be an isolated flyback converter configured to receive input DC power via the connector and convert the input DC power to one of a stepped up voltage DC power or a stepped down voltage DC power.

The conductive plate may take any of various forms. For example, the conductive plate may define one or more slits, each of the one or more slits extending radially inward from a perimeter of the conductive plate. In a further example, the antenna may be a multi-zone antenna. In yet a further example, the multi-zone antenna may include a first transmission coil and a second transmission coil and wherein, when the antenna is positioned proximate to the conductive plate, a first slit of the one or more silts is positioned proximate to the first transmission coil and a second slit of the one or more slits is positioned proximate to the second transmission coil. In another further example, a first slit of the one or more slits may include a hatched slit that is configured to be positioned proximate to the substrate.

In another aspect, a wireless power transmission system includes an antenna, a tuning system, a power conditioning system, a controller, a substrate, and a conductive plate. The controller may include a communications channel. The substrate may be configured for mounting of one or more of the tuning system, the power conditioning system, the controller, or combinations thereof and the substrate defining an analog grounding point, the analog grounding point electrically connected one or more ground connections of each of the tuning system, the power conditioning system, and the controller. The conductive plate may be electrically connected to the single-point grounding point and electrically separated from each of the antenna, the tuning system, the power conditioning system, and the controller.

The wireless power transmission system may include various other components. For example, the wireless power transmission system may further include a common mode choke in electrical connection between an input power source to the wireless power transmission system and the power conditioning system.

In another example, the wireless power transmission system may further include a digital ground circuit, the digital ground circuit configured to connect the communications channel of the controller to digital ground. In a further example, the digital ground circuit may be configured to connect an external communications channel associated with an external communications source to digital ground and thereby facilitate communications between the external communications channel and the communications channel.

In yet another example, the wireless power transmission system may further include a communications isolator circuit, wherein the communications channel is connected to digital ground via the communications isolator circuit.

In yet another example, the power conditioning system, the tuning system, and the power conditioning system may each be connected to analog ground via the analog grounding point. In a further example, the controller may include at least one other input or output pin that is connected to analog ground via the analog grounding point.

In yet another aspect, a wireless transmission system includes (i) a controller configured to generate a driving signal, (ii) a power conditioning system configured to generate a power signal based on the driving signal, (iii) a ground, and (iv) a printed circuit board (PCB) antenna. The PCB antenna may include at least one coil layer and a filter layer. The at least one coil layer is configured to generate a wireless power signal based on the power signal. The at least one coil layer includes (i) one or more turns, (ii) a first coil end, and (iii) a second coil end. The at least one coil layer is electrically connected to the power conditioning system via (i) a positive electrical node connected to the first coil end and (ii) a negative electrical node connected to the second coil end. The filter layer is positioned in a stack-up with the at least one coil layer and includes one or more tines each (i) comprising a conductive material, (ii) positioned proximate to the plurality of turns, and (iii) terminating at one end. The filter layer includes a filter end that is electrically connected to the ground, wherein the filter layer is configured to (i) absorb an electric field (E-field) emitted by the at least one coil layer when generating the wireless power signal and (ii) route the absorbed E-field to the ground.

The filter layer may take any of various forms. For example, the filter layer may include one or more partial turns each (i) comprising a tine of the one or more tines and (ii) terminating at the filter end. In such an example, the one or more partial turns may be each positioned proximate to a respective turn of the one or more turns. In another example, the filter layer may include an outer partial turn that terminates at the filter end and the one or more tines extend inward from the outer partial turn. In a further example, the one or more tines each extend laterally from the outer turn and are positioned to overlay the one or more turns. In yet a further example, positioning of the one or more tines defines a hole in the filter layer. In another further example, the coil layer further comprises one or more crossovers and the filter layer further comprises one or more sets of teeth that are each positioned proximate to one of the one or more crossovers.

The at least one coil layer may take any of various forms. For example, the at least one coil layer may include a first coil layer and a second coil layer. In a further example, the first and second coil layers may combine to form a multi-layer multi-turn inductor. In another further example, the filter layer may be positioned between the first coil layer and the second coil layer.

In yet another aspect, a PCB antenna for a wireless power transmission system includes at least one coil layer and a filter layer. The at least one coil layer is configured to generate a wireless power signal based on a power signal. The at least one coil layer includes (i) one or more turns, (ii) a first coil end, and (iii) a second coil end. The at least one coil layer is electrically connected to a power conditioning system via (i) a positive electrical node connected to the first coil end and (ii) a negative electrical node connected to the second coil end. The filter layer is positioned in a stack-up with the at least one coil layer and includes one or more tines each (i) comprising a conductive material, (ii) positioned proximate to the plurality of turns, and (iii) terminating at one end. The filter layer includes a filter end that is electrically connected to a ground of the wireless transmission system, wherein the filter layer is configured to (i) absorb an electric field (E-field) emitted by the at least one coil layer when generating the wireless power signal and (ii) route the absorbed E-field to the ground.

The filter layer may take any of various forms. For example, the filter layer may include one or more partial turns each (i) comprising a tine of the one or more tines and (ii) terminating at the filter end. In such an example, the one or more partial turns may be each positioned proximate to a respective turn of the one or more turns. In another example, the filter layer may include an outer partial turn that terminates at the filter end and the one or more tines extend inward from the outer partial turn. In a further example, the one or more tines each extend laterally from the outer turn and are positioned to overlay the one or more turns. In yet a further example, positioning of the one or more tines defines a hole in the filter layer. In another further example, the coil layer further comprises one or more crossovers and the filter layer further comprises one or more sets of teeth that are each positioned proximate to one of the one or more crossovers.

The at least one coil layer may take any of various forms. For example, the at least one coil layer may include a first coil layer and a second coil layer. In a further example, the first and second coil layers may combine to form a multi-layer multi-turn inductor. In another further example, the filter layer may be positioned between the first coil layer and the second coil layer.

These and other aspects and features of the present disclosure will be better understood when read in conjunction with the accompanying drawings.

### BRIEF DESCRIPTION OF THE DRAWINGS

FIG. 1A is a block diagram of an embodiment of a system for wirelessly transferring one or more of electrical power, electronic data, or combinations thereof.

FIG. 1B is another block diagram of an embodiment of the system of FIG. 1A.

FIG. 2 is a block diagram further illustrating components of a wireless transmission system of the system of FIGS. 1A-B, including EMI mitigation features.

FIG. 3 is a block diagram illustrating components of a sensing system of the wireless transmission system of FIGS. 1-2.

FIG. 4A is a block diagram illustrating components of a first power conditioning system of the wireless transmission system of FIGS. 1-2.

FIG. 4B is a block diagram of elements of the wireless transmission system of FIGS. 1-4A, further illustrating components of an amplifier of the power conditioning system of FIG. 4A and signal characteristics for wireless power transmission.

FIG. 4C is an electrical schematic diagram of elements of the wireless transmission system of FIGS. 1-4B, further illustrating components of an amplifier of the power conditioning system.

FIG. 4D is another block diagram illustrating components of a second power conditioning system of the wireless transmission system of FIGS. 1-2.

FIG. 4E is an electrical schematic diagram of elements of an isolated flyback converter of the power conditioning system of FIG. 4D.

FIG. 5A is a block diagram further illustrating components of another wireless transmission system for use with the system of FIGS. 1A and 1B, including EMI mitigation features.

FIG. 5B is an exploded perspective view of an example implementation of the wireless transmission system of FIG. 5A.

FIG. 5C is a bottom view of the example implementation of the wireless transmission system of FIGS. 5A and 5B, with portions of a housing thereof not shown.

FIG. 5D is a bottom view of a conductive plate of the example implementation of the wireless transmission system of FIGS. 5A-C.

FIG. 5E is a bottom view of the example implementation of the wireless transmission system of FIGS. 5A and 5B, with portions of a housing thereof not shown.

FIG. 6A is a block diagram further illustrating components of yet another wireless transmission system for use with the system of FIGS. 1A and 1B, including EMI mitigation features.

FIG. 6B is a block diagram further illustrating components of yet another wireless transmission system for use with the system of FIGS. 1A and 1B, including EMI mitigation features.

FIG. 7A is a block diagram illustrating components of the wireless receiver system of FIGS. 1A and 1B.

FIG. 7B is another block diagram illustrating components of the wireless receiver system of FIGS. 1A and 1B, further illustrating signal characteristics for wireless power receipt and data receipt and transmission.

FIG. 8A is a top view of an embodiment of an antenna, for use as one or more of a transmitter antenna and/or a receiver antenna of the systems of FIGS. 1-4C, 6, and 7.

FIG. 8B is a top view of another embodiment of an antenna, for use as one or more of a transmitter antenna and/or a receiver antenna of the systems of FIGS. 1-4C, 6, and 7.

FIG. 9A is a stack-up view of an example configuration of a multi-layered antenna, for use as one or more of a transmitter antenna and/or a receiver antenna of the systems of FIGS. 1-4C, 6, and 7.

FIG. 9B is a top view of an embodiment of a multi-layered antenna comprising a coil layer and a filter layer, for use as one or more of a transmitter antenna and/or a receiver antenna of the systems of FIGS. 1-4C, 6, and 7.

FIG. 9C is a top view of the filter layer of the multi-layered antenna of FIG. 9B.

FIG. 9D is a top view of the coil layer of the multi-layered antenna of FIG. 9B.

FIG. 9E is a top view of another embodiment of a multi-layered antenna comprising a coil layer and a filter layer, for use as one or more of a transmitter antenna and/or a receiver antenna of the systems of FIGS. 1-4C, 6, and 7.

FIG. 9F is a top view of the filter layer of the multi-layered antenna of FIG. 9F.

FIG. 9G is a top view of the coil layer of the multi-layered antenna of FIG. 9F.

FIG. 9H is a stack-up view of another example configuration of a multi-layered antenna, for use as one or more of a transmitter antenna and/or a receiver antenna of the systems of FIGS. 1-4C, 6, and 7.

FIG. 9I is a stack-up view of yet another example configuration of a multi-layered antenna, for use as one or more of a transmitter antenna and/or a receiver antenna of the systems of FIGS. 1-4C, 6, and 7.

FIG. 9J is a stack-up view of yet another example configuration of a multi-layered antenna, for use as one or more of a transmitter antenna and/or a receiver antenna of the systems of FIGS. 1-4C, 6, and 7.

FIG. 10A is a top view of a multi-zone wireless power transmission antenna, for use as the wireless transmission antenna in the system(s) of FIGS. 1-6B.

FIG. 10B is another top view of a multi-zone wireless power transmission antenna, for use as the wireless transmission antenna in the system(s) of FIGS. 1-6B.

FIG. 11 is a block diagram for a method of operating a wireless power transmission system, such as those disclosed with respect to FIGS. 1-6B.

FIG. 12 is a block diagram for a method of operating a wireless power receiver system, such as those disclosed with respect to FIGS. 1A, 1B, 7A, and 7B.

FIG. 13A is an isometric view of example eyewear, within which the wireless power transfer systems disclosed herein may be implemented for wireless power transfer to the eyewear.

FIG. 13B is an isometric view of the exemplary eyewear of FIG. 18A and an associated case for the eyewear, within which the wireless power transfer systems disclosed herein may be implemented for wireless power transfer to the eyewear.

FIG. 14A is an isometric view of a wearable device and an associated charger for the wearable device, within which the wireless power transfer systems disclosed herein may be implemented for wireless power transmission from the charger to the wearable device, within which the wireless power transfer systems disclosed herein may be implemented for wireless power transfer to the wearable device.

FIG. 14B is a side view of the wearable device and charger of FIG. 19A.

FIG. 15A is a side view, with cross-sectional denotations, of exemplary earbuds and an associated charging case, within which the wireless power transfer systems disclosed herein may be implemented for wireless power transfer to the earbuds.

FIG. 15B is a side view of alternative exemplary earbuds and an associated charging surface, within which the wireless power transfer systems disclosed herein may be implemented for wireless power transfer to the earbuds.

FIG. 16A is a front view of an example body that may be equipped with an implanted device having a wireless power receiver system, within which the wireless power and data transfer systems disclosed herein may be implemented for wireless power and data transfer to the implanted device.

FIG. 16B is a side cross sectional view of a portion of the being of FIG. 21A illustrating the implanted device with respect to tissue(s) of the being and an external implanted device charger, within which the wireless power and data transfer systems disclosed herein may be implemented for wireless power and data transfer to the implanted device.

While the following detailed description will be given with respect to certain illustrative embodiments, it should be understood that the drawings are not necessarily to scale and the disclosed embodiments are sometimes illustrated diagrammatically and in partial views. In addition, in certain instances, details which are not necessary for an understanding of the disclosed subject matter or which render other details too difficult to perceive may have been omitted. It should therefore be understood that this disclosure is not limited to the particular embodiments disclosed and illustrated herein, but rather to a fair reading of the entire disclosure and claims, as well as any equivalents thereto. Additional, different, or fewer components and methods may be included in the systems and methods.

### DETAILED DESCRIPTION

Near field magnetic induction (NFMI) is often utilized for wireless power transfer. NFMI enables the transfer of signals wirelessly through magnetic that induces a current between a transmitter antenna and a receiver antenna coupled with the transmitter antenna. To that end, NFMI may be referred to as “inductive coupling,” which may be a wireless power transmission technique that utilizes an alternating electromagnetic field to transfer electrical energy between two antennas.

NFMI utilizes this coupling between antennas, in the near field, for wireless transmission of magnetic energy between two magnetically coupled coils that are tuned to resonate at a similar frequency. Such near-field magnetic coupling may enable wireless power transmission via resonant transmission of confined magnetic fields. This near-field magnetic coupling may provide connection via “mutual inductance,” which refers to the production of an electromotive force in a circuit by a change in current in at least one other circuit magnetically coupled to the first.

To facilitate NFMI, the inductor coils of either the transmitter antenna or the receiver antenna are strategically positioned to facilitate reception and/or transmission of wirelessly transferred electrical signals, via NFMI.

Transmission of one or more of electrical energy, electrical power, electromagnetic energy and/or electronic data signals from one of such coiled antennas to another, generally, operates at an operating frequency and/or an operating frequency range. An operating frequency, generally, refers to the frequency at which antennas of a wireless system are tuned to for purposes of wireless power and/or data transfer. The operating frequency may be selected for any of a variety of reasons, such as, but not limited to, power transfer efficiency characteristics, power level characteristics, self-resonant frequency restraints, design requirements, adherence to standards bodies' required characteristics (e.g, electromagnetic interference (EMI) requirements, specific absorption rate (SAR) requirements, etc.), bill of materials (BOM) restrictions, and/or form factor constraints, among other things. It is to be noted that, “self-resonating frequency,” as known to those having skill in the art, generally refers to the resonant frequency of a passive component (e.g., an inductor) due to the parasitic characteristics of the component.

Antenna operating frequencies may comprise relatively high operating frequency ranges, examples of which may include, but are not limited to, 6.78 MHz (e.g., in accordance with the Rezence and/or Airfuel interface standard and/or any other proprietary interface operating at a frequency of 6.78 MHz), 13.56 MHz (e.g., in accordance with the NFC standard, defined by ISO/IEC standard 18092), 27 MHz, and/or an operating frequency of another proprietary operating mode. Such operating frequencies of the antennas may be operating frequencies designated by the International Telecommunications Union (ITU) in the Industrial, Scientific, and Medical (ISM) frequency bands, which may include the aforementioned 6.78 MHz, 13.56 MHz, and 27 MHz frequency bands, which are designated for use in wireless power transfer. In systems wherein a wireless power transfer system is operating within the NFC-WLC standards and/or draft standards, the operating frequency may be in a range of about 13.553 MHz to about 13.567 MHz.

When such systems are operating to wirelessly transfer power from a transmission system to a receiver system via the antennas, it is often desired to simultaneously and/or at a different time communicate electronic data between the systems. In some example systems, wireless-power-related communications (e.g., validation procedures, electronic characteristics data, voltage data, current data, device type data, among other contemplated data communications related to wireless power transfer) are performed using in-band communications.

However, it is certainly possible that the connection of devices, via NFMI, may be utilized in transferring data, over the coupled antennas, that is not related to the instant wireless power transfer. Such data transfer may utilize the NFMI connection as a “pass through” or other data connection medium, for transferring data to/from a device operatively associated with the wireless receiver system. This data transfer, for example, may occur simultaneously to wireless power transfer, via NFMI.

In-band communications may be communications signals that are encoded in a carrier signal, wherein the carrier signal is generated via NFMI between two or more coupled antennas. In-band communications, as utilized by NFMI systems, are communication signals that are encoded into the induced signal between antennas that are coupled via NFMI. In some examples, in-band communications signals are encoded by modulating a carrier signal (e.g. a wireless power signal or a polling signal) between coupled transmitter and receiver antennas, by a system selectively damping the induced signal. Either the transmitting or receiving system of an NFMI coupled pair may selectively damp the signal, to encode the in-band signals.

In some examples, in-band communication signals in an NFMI system are encoded as amplitude shift keyed (ASK) signals, which, in some examples, may include on-off-keyed (OOK) signals, which are a subset of ASK signals. In an ASK signal, the wireless data signals are encoded by damping the voltage of the magnetic field between a wireless transmission system and a wireless receiver system. Such damping and subsequent re-rising of the voltage in the field is performed based on an underlying encoding scheme for the wireless data signals (e.g., binary coding, Manchester coding, pulse-width modulated coding, among other known or future-developed coding systems and methods). The receiver of the wireless data signals (e.g., a wireless transmission system in this example) can then detect rising and falling edges of the voltage of the induced field and decode said rising and falling edges to demodulate the wireless data signals.

While operating to wirelessly transfer power and/or data, components of wireless transmission systems may be susceptible to generating unwanted and/or excessive electromagnetic interference (“EMI”). EMI may refer to any unwanted electromagnetic interference that is absorbed by an electronic device (e.g. a consumer electronic device) or electrical system (e.g., a power grid, a power outlet, etc.) within an environment associated with the source of the unwanted interference. EMI may take the form of noise received by or conducted upon a conductor (e.g., an antenna, a wire, a conductive trace, etc.) of another electronic device or electrical system, independent of the source of the unwanted interference.

EMI can be experienced by another electronic device or system, within a common environment with a source of unwanted interference, in a variety of forms. For example, EMI may take the form of one or both of conducted emissions and radiated emissions. Conducted emissions may refer to emissions that are generated by a source of EMI that emits signals that cause a conductive material (e.g., an antenna, a wire, a conductive trace, etc.) of another device to resonate based on the EMI signals, to generate noise. Often, conducted emissions can take the form of noise that is conducted to upstream electrical devices of the source of the EMI (e.g., wires connecting the EMI source to an input power source, connected electronic sources via a wire, EMI causing a wire to conduct noise as if it were an antenna, etc.). Radiated emissions refer to EMI emissions that travel wirelessly throughout the environment in which the source of EMI operates. To that end, radiated emissions, as EMI noise, may be unwantedly received by other electronic devices that are not intended to or tuned to receive said noise.

Such noise may take the form of common-mode noise or differential-mode noise. Common-mode noise, generally, refers to noise that is conducted on all wires in a circuit in the same direction. Differential-mode noise, generally, refers to noise that is conducted on a circuit in the opposite direction to the intended current flow of the circuit. EMI-based noise may take various forms based on these principles.

Common mode noise, in particular, is an unwanted emission in prior technologies for wireless power transfer. Common mode noise may be noise that is generated due to capacitive coupling between an antenna of a wireless power transfer system and ground reference planes (e.g., an earth ground, such as floors, walls, or any other reference ground plane). Wireless power transfer antennas often, out of necessity to generate/receive signals for wireless power transfer, are associated with strong electric fields (“E-fields”) and strong magnetic fields that can easily capacitively couple to ground reference planes. Such coupling, then, provides a signal path for the common mode noise which, via this signal path, will necessarily attempt to return (through an undesirable path, such as a reference ground plane) to the wireless power transfer antenna (as it is the source of the noise).

For example, consider that a wireless power transmitter antenna is integrated in a consumer electronic device. The consumer electronic device receives electrical power (for operating the wireless power transmitter and/or any other components thereof) via a cable that is plugged into an electrical plug (e.g., a universal serial bus (USB) plug) that is plugged into a wall outlet. In this scenario, the cable connecting the consumer electronic device to the wall outlet may be a return path for the common mode noise to capacitively couple with ground and, as such, the common mode noise will radiate via the cable. For example, these cables may be of a significant length (e.g., of about 0.5 meters (m) to about 3 m long) and, thus, if common mode noise is large enough, the common mode noise can radiate as strong E-fields from the cable, which can cause EMI and, thus, failures to pass EMI regulatory tests. Even with low instances of common mode noise (e.g., with a current of about 10 microamps (μA) to about 50 μA), regulatory tests may be failed due to common mode noise at both an operating frequency of the wireless power transmitter and/or common mode noise at harmonic frequencies of the operating frequency.

While discussed, generally, as conducted or radiated emissions that take the form of either common-mode noise or differential-mode noise, EMI may take various other forms. However, in whatever form, EMI noise is undesirable for a variety of reasons.

The main consequence of EMI is that excessive EMI-based noise can affect the performance of other electronic devices within the environment of an electronic device that is generating EMI. The effects of EMI range from trivial or annoying (e.g., light speaker hum on audio systems, unwanted noise on a recorded signal from a microphone, light disruption in signal quality for personal radios, etc.) to unsafe or dangerous to health (e.g., disruptions in emergency response communications, disruptions in transit communication systems, interference altering functions of a pacemaker, etc.). Accordingly, various jurisdictions regulate how much EMI-based noise is acceptable for a market product to produce. To that end, if a device emits more EMI-based noise than is acceptable under a given regulation, said device cannot be sold in the jurisdiction of said regulation.

Further, most consumer electronic devices in the United States of America must be cleared by the Federal Communications Commission (FCC), to ensure that consumer electronic devices for sale on commercial markets do not generate excessive EMI.

For example, FCC Part 15 (47 C.F.R. Part 15) and/or FCC Part 18 (47 C.F.R. Part 18) may be a focus for testing and certifying wireless power transmitters. Such codes provide limits for the EMI noise (measured in decibels (dB)) that are acceptable. Other jurisdictions may have their own EMI noise-based regulations as well, such as, but not limited to the European Comité International Spécial des Perturbations Radioélectriques 11 (CISPR 11) standard and its related European standard EN 55022, CISPR 11, EN 303 417, etc.

Certification under such EMI noise-based regulations may be time consuming (time needed to test, repeated testing due to failure, etc), may be costly (cost of laboratory time for testing prior to official testing, labor costs, materials and equipment costs, etc.), and/or may cause timing concerns (delaying product launch due to failed EMI testing, delaying product teams' progress on other projects, etc.).

Solutions for mitigating some EMI do exist, but may not be sufficient. For example, many electronic circuits employ EMI filters that can effectively filter out some or most of the EMI based noise generated and, thus, allow for passage of certification under a given regulation. Further, another common EMI mitigation technique may be to utilize some form of shielding materials around sources of EMI-based noise to dampen or mitigate such noise. Further still, more complex circuitry or components may be utilized to reduce common-mode noise (e.g. a common mode choke, a common mode capacitor, etc.) and/or differential-mode noise (e.g., a Pi filter, harmonic cancelling active filters, etc.).

While useful in mitigating EMI, these mitigation techniques may also have negative effects to the overall wireless power transfer system performance. For example, by utilizing these components, greater losses in power efficiency in the system may occur, which, in turn, may lead to higher thermal rises within the system (e.g., as heat emission via one or more components of the wireless power transfer system) and/or signal degradation due to the introduction of these components.

Further, due to the high levels of propagating magnetic fields and E-fields that occur during wireless power transfer (and their close proximity to reference ground planes), wireless power transmitters are increasingly susceptible to generating EMI-based noise and may be difficult to certify under any given regulation. While the EMI-based noise is, generally, near field for radiated emissions and, thus, may have low risk of interference with a given other electronic device in an environment, wireless power transmitters are still subject to regulatory scrutiny and, thus, even near field emissions must be mitigated.

To that end, the wireless transmission systems disclosed herein may include one or more new EMI mitigation features. The EMI mitigation features disclosed herein may improve upon existing technology for mitigating EMI-based noise by focusing the mitigation on emission sources that are unique to wireless power transmitters.

For example, one of the EMI mitigation features disclosed herein regards a single point grounding strategy wherein all grounded elements of a system are focused to a single point proximate to an input power source. Thus, with the ground and potential lines for conducting emissions all dissipating to the single-point ground and spread over a conductive plate, EMI noise feedback on an input power supply and/or a wire connecting the wireless power transmitter and the input power supply may be mitigated. By using the single-point ground, this creates a lower impedance path for noise that is created by a wireless power transmitter that would otherwise be coupling to a reference ground plane within the environment. By connecting to the single-point ground, capacitance is increased within the system which causes a lower impedance path for the noise to travel through, when compared to the impedance path that would be created between the electrical components and a reference ground plane.

In another implementation, a wireless transmission antenna may comprise an antenna layer that creates a lower impedance path for conducted EMI (e.g., common mode noise), when compared to the impedance path that would be created between the electrical components and a reference ground plane. By utilizing the filter layer, E-Field emissions (and harmonic emissions associated therewith) that are generated by the wireless transmission antenna may be captured, thus reducing the common mode noise that may travel through alternative signal paths within or associated with the wireless transmission system (e.g., reducing common mode noise that travels through a cable associated with the wireless transmission system).

Further still, other EMI mitigation features may include split grounding strategies that divert communications-based elements of the circuit to a digital ground rather than connecting to an analog ground. Thus, the communications systems may be immune to feedback and/or EMI based noise that can be generated by switching components of the wireless transmission system (e.g., an amplifier).

By utilizing the disclosed EMI mitigation features in wireless transmission systems, various benefits are achieved-such as avoiding the aforementioned “trivial or annoying” and “unsafe or dangerous to health” consequences. Regardless, by utilizing the disclosed EMI mitigation features, regulatory concerns may be mitigated and, thus, the discussed drawbacks associated with failed regulatory testing may be mitigated.

In particular, by utilizing a filter layer in a wireless transmission antennal, common mode noise can be drastically reduced, while also reducing cost of bill of materials for the wireless power transmission system. For example, a filter layer for a wireless transmission system may be implemented in a printed circuit board (PCB) based wireless transmission system by simply adding a layer to the PCB for the wireless transmission antenna (with insulation therebetween). In most circumstances, adding this filter layer is far more cost effective than previous (and less successful) components for mitigating common mode noise (e.g., common mode chokes).

In the following description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings. For example, as will be discussed, an NFMI system operating at an operating frequency associated with Near Field Communications (NFC) is used herein as an example for a NFMI power and/or data system. However, other wired and wireless communications techniques may be used while embodying the principles of the present disclosure.

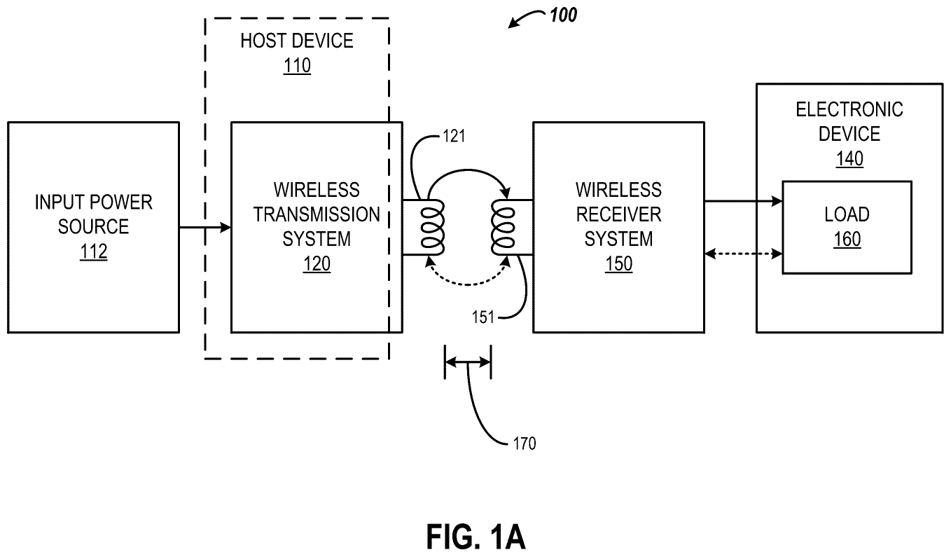

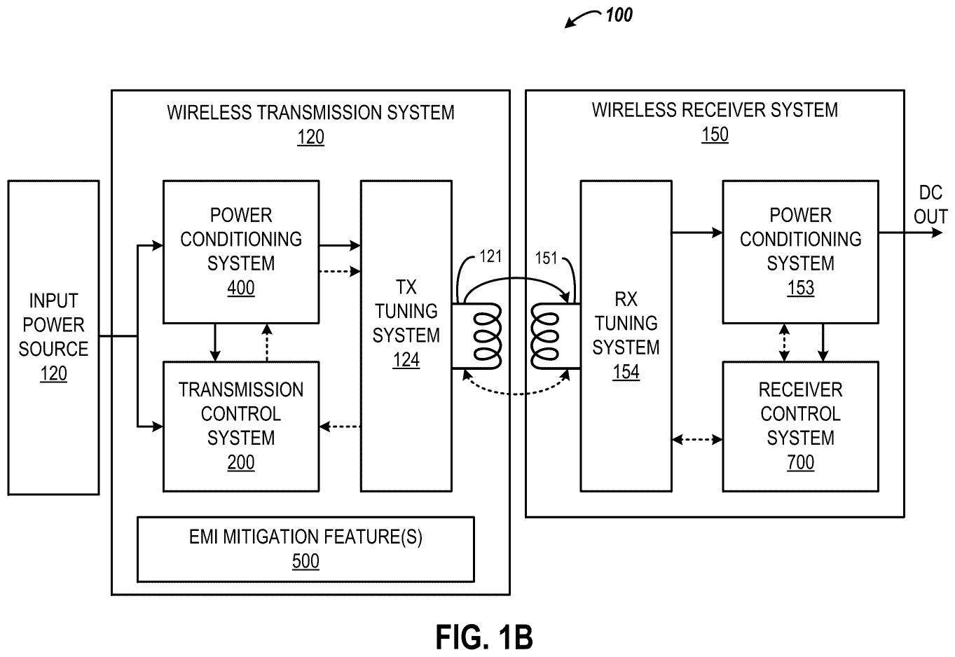

Referring now to the drawings and with specific reference to FIG. 1, a wireless power transfer system 100 is illustrated. The wireless power transfer system 10 provides for the wireless transmission of electrical signals, such as, but not limited to, electrical energy, electrical power, electrical power signals, electromagnetic energy, and electronically transmittable data (“electronic data”). As used herein, the term “electrical power signal” refers to an electrical signal transmitted specifically to provide meaningful electrical energy for charging and/or directly powering a load, whereas the term “electronic data signal” refers to an electrical signal that is utilized to convey data across a medium. Further still, “polling signals,” as defined herein, refer to electrical power signals having a sufficient power level to induce a current and act as a carrier signal for in-band wireless data signals. Optionally, polling signals may be harvested by components of a device receiving the polling signals. In some examples, polling signals may be harvested by passive electronic devices to provide electrical power for operating the passive electronic device.

The wireless power transfer system 100 provides for the wireless transmission of electrical signals via NFMI. As shown in the embodiment of FIG. 1A, the wireless power transfer system 100 includes a wireless transmission system 120 and a wireless receiver system 130. The wireless receiver system is configured to receive electrical signals, via a receiver antenna 151, from a transmission antenna 121 of the wireless transmission system 120. In some examples, such as examples wherein the wireless power transfer system is configured for wireless power transfer via NFC-WLC draft or accepted standard, the wireless transmission system 120 may be referenced as a “poller” of the a NFC-DC wireless transfer system and the wireless receiver system 150 may be referenced as a “listener” of a NFC-DC wireless transfer system.

As illustrated, the wireless transmission system 120 and wireless receiver system 130 may be configured to transmit electrical signals across, at least, a separation distance or gap 170. A separation distance or gap, such as the gap 170, in the context of a wireless power transfer system, such as the system 100, does not include a physical connection, such as a wired connection. There may be intermediary objects located in a separation distance or gap, such as, but not limited to, air, a counter top, a casing for an electronic device, a plastic filament, an insulator, a mechanical wall, among other things; however, there is no physical, electrical connection at such a separation distance or gap.

Thus, the combination of the wireless transmission system 120 and the wireless receiver system 130 creates an electrical connection without the need for a physical connection. As referenced herein, the term “electrical connection” refers to any facilitation of a transfer of an electrical current, voltage, and/or power from a first location, device, component, and/or source to a second location, device, component, and/or destination. An “electrical connection” may be a physical connection, such as, but not limited to, a wire, a trace, a via, among other physical electrical connections, connecting a first location, device, component, and/or source to a second location, device, component, and/or destination. Additionally or alternatively, an “electrical connection” may be a wireless power and/or data transfer, such as, but not limited to, magnetic, electromagnetic, resonant, and/or inductive field, among other wireless power and/or data transfers, connecting a first location, device, component, and/or source to a second location, device, component, and/or destination.

In some cases, the gap 170 may also be referenced as a “Z-Distance,” because, if one considers an antenna 121, 151 each to be disposed substantially along respective common X-Y planes, then the distance separating the antennas 121, 151 is the gap in a “Z” or “depth” direction. However, flexible and/or non-planar coils are certainly contemplated by embodiments of the present disclosure and, thus, it is contemplated that the gap 170 may not be uniform, across an envelope of connection distances between the antennas 121, 151. It is contemplated that various tunings, configurations, and/or other parameters may alter the possible maximum distance of the gap 170, such that electrical transmission from the wireless transmission system 120 to the wireless receiver system 130 remains possible.

The wireless power transfer system 100 operates when the wireless transmission system 120 and the wireless receiver system 130 are coupled. As used herein, the terms “couples,” “coupled,” and “coupling” generally refer to magnetic field coupling, which occurs when a transmitter and/or any components thereof and a receiver and/or any components thereof are coupled to each other through a magnetic field. Such coupling may include coupling, represented by a coupling coefficient (k), that is at least sufficient for an induced electrical power signal, from a transmitter, to be harnessed by a receiver. Coupling of the wireless transmission system 120 and the wireless receiver system 130, in the system 100, may be represented by a resonant coupling coefficient of the system 100 and, for the purposes of wireless power transfer, the coupling coefficient for the system 100 may be in the range of about 0.01 to about 0.9.

As illustrated, the wireless transmission system 120 may be associated with a host device 110, which may receive power from an input power source 112. The host device 110 may be any electrically operated device, circuit board, electronic assembly, dedicated charging device, or any other contemplated electronic device. Example host devices 110, with which the wireless transmission system 120 may be associated therewith, include, but are not limited to including, a device that includes an integrated circuit, cases for wearable electronic devices, receptacles for electronic devices, a portable computing device, wearable charging devices, on-device chargers, clothing configured with electronics, storage medium for electronic devices, charging apparatus for one or multiple electronic devices, dedicated electrical charging devices, activity or sport related equipment, goods, and/or data collection devices, among other contemplated electronic devices.

As illustrated, one or both of the wireless transmission system 120 and the host device 110 are operatively associated with an input power source 112. The input power source 112 may be or may include one or more electrical storage devices, such as an electrochemical cell, a battery pack, and/or a capacitor, among other storage devices. Additionally or alternatively, the input power source 112 may be any electrical input source (e.g., any alternating current (AC) or direct current (DC) delivery port) and may include connection apparatus from said electrical input source to the wireless transmission system 120 (e.g., transformers, regulators, conductive conduits, traces, wires, equipment, computer, camera, mobile phone, and/or other electrical device connection ports and/or adaptors, such as but not limited to USB ports and/or adaptors, among other contemplated electrical components).

Electrical energy received by the wireless transmission system 120 is then used for at least two purposes: to provide electrical power to internal components of the wireless transmission system 120 and to provide electrical power to the transmission antenna 121. The transmission antenna 121 is configured to wirelessly transmit the electrical signals conditioned and modified for wireless transmission by the wireless transmission system 120 via NFMI.

The transmission antenna 121 and the receiver antenna 151 of the present disclosure may be configured to transmit and/or receive electrical power having a magnitude that ranges from about 10 milliwatts (mW) to about 500 watts (W). In one or more embodiments the inductor coil of the transmission antenna 121 is configured to resonate at a transmitting antenna resonant frequency or within a transmitting antenna resonant frequency band.

As known to those skilled in the art, a “resonant frequency” or “resonant frequency band” refers a frequency or frequencies wherein amplitude response of the antenna is at a relative maximum, or, additionally or alternatively, the frequency or frequency band where the capacitive reactance has a magnitude substantially similar to the magnitude of the inductive reactance. In one or more embodiments, the transmitting antenna resonant frequency is at a high frequency, as known to those in the art of wireless power transfer.

The wireless receiver system 130 may be associated with an example electronic device 140, wherein the electronic device 140 may be any device that requires electrical power for any function and/or for power storage (e.g., via a battery and/or capacitor). Additionally, the electronic device 140 may be any device capable of receipt of electronically transmissible data. For example, the device may be, but is not limited to being, a handheld computing device, a mobile device, a portable appliance, a computer peripheral, an integrated circuit, an identifiable tag, a kitchen utility device, an electronic tool, an electric vehicle, a game console, a robotic device, a wearable electronic device (e.g., an electronic watch, a fitness tracker, electronically modified glasses, altered-reality (AR) glasses, virtual reality (VR) glasses, among other things), a portable scanning device, a portable identifying device, a sporting good, an embedded sensor, an Internet of Things (IoT) sensor, IoT enabled clothing, IoT enabled recreational equipment, industrial equipment, medical equipment, a medical device, a tablet computing device, a portable control device, a remote controller for an electronic device, a gaming controller, among other things.

For the purposes of illustrating the features and characteristics of the disclosed embodiments, arrow-ended lines are utilized to illustrate transferrable and/or communicative signals and various patterns are used to illustrate electrical signals that are intended for power transmission and electrical signals that are intended for the transmission of data and/or control instructions. Solid lines indicate signal transmission of electrical energy over a physical and/or wireless power transfer, in the form of power signals that are, ultimately, utilized in wireless power transmission from the wireless transmission system 120 to the wireless receiver system 130. Further, dotted lines are utilized to illustrate electronically transmittable data signals, which ultimately may be wirelessly transmitted from the wireless transmission system 120 to the wireless receiver system 130.

While the systems and methods herein illustrate the transmission of wirelessly transmitted energy, wireless power signals, wirelessly transmitted power, wirelessly transmitted electromagnetic energy, and/or electronically transmittable data, it is certainly contemplated that the systems, methods, and apparatus disclosed herein may be utilized in the transmission of only one signal, various combinations of two signals, or more than two signals and, further, it is contemplated that the systems, method, and apparatus disclosed herein may be utilized for wireless transmission of other electrical signals in addition to or uniquely in combination with one or more of the above mentioned signals. In some examples, the signal paths of solid or dotted lines may represent a functional signal path, whereas, in practical application, the actual signal is routed through additional components en route to its indicated destination. For example, it may be indicated that a data signal routes from a communications apparatus to another communications apparatus; however, in practical application, the data signal may be routed through an amplifier, then through a transmission antenna, to a receiver antenna, where, on the receiver end, the data signal is decoded by a respective communications device of the receiver.

Turning now to FIG. 1B, the wireless power transfer system 100 is illustrated as a block diagram including example sub-systems of both the wireless transmission system 120 and the wireless receiver system 130. The wireless transmission system 120 may include, at least, a power conditioning system 600, a transmission control system 200, a transmission tuning system 124, and the transmission antenna 121. A first portion of the electrical energy input from the input power source 112 is configured to electrically power components of the wireless transmission system 120 such as, but not limited to, the transmission control system 200. A second portion of the electrical energy input from the input power source 112 is conditioned and/or modified for wireless power transmission, to the wireless receiver system 130, via the transmission antenna 121. Accordingly, the second portion of the input energy is modified and/or conditioned by the power conditioning system 600. While not illustrated, it is certainly contemplated that one or both of the first and second portions of the input electrical energy may be modified, conditioned, altered, and/or otherwise changed prior to receipt by the power conditioning system 600 and/or transmission control system 200, by further contemplated subsystems (e.g., a voltage regulator, a current regulator, switching systems, fault systems, safety regulators, among other things).

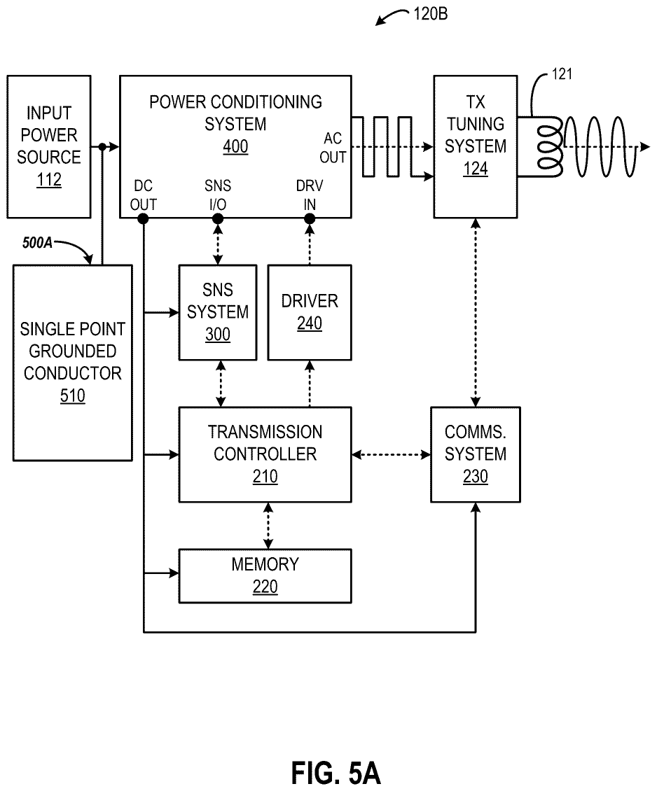

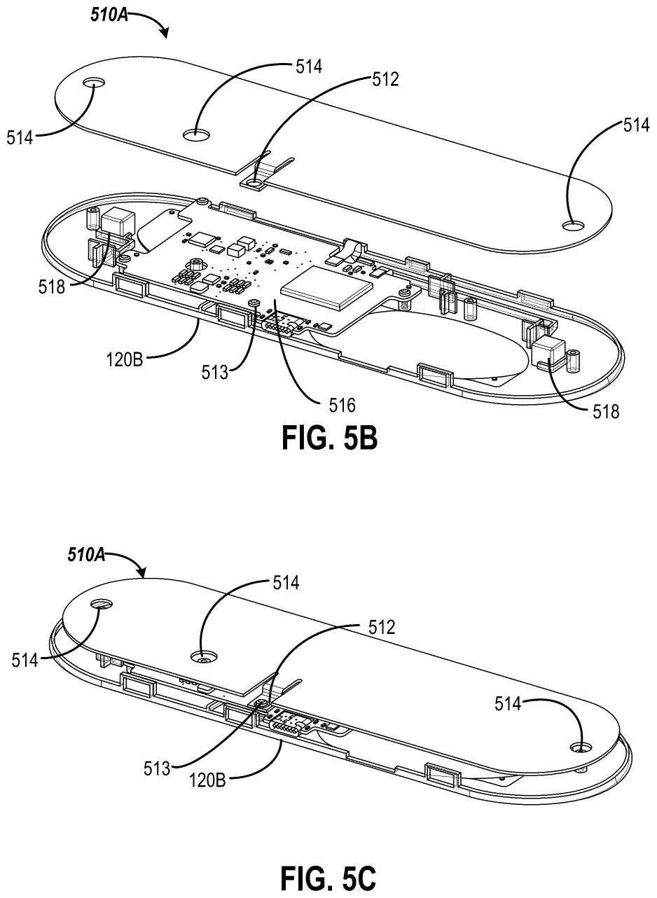

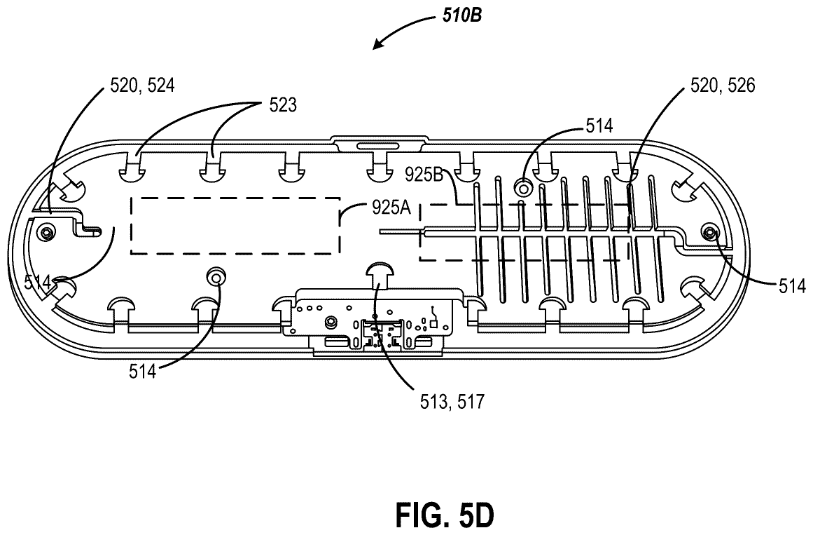

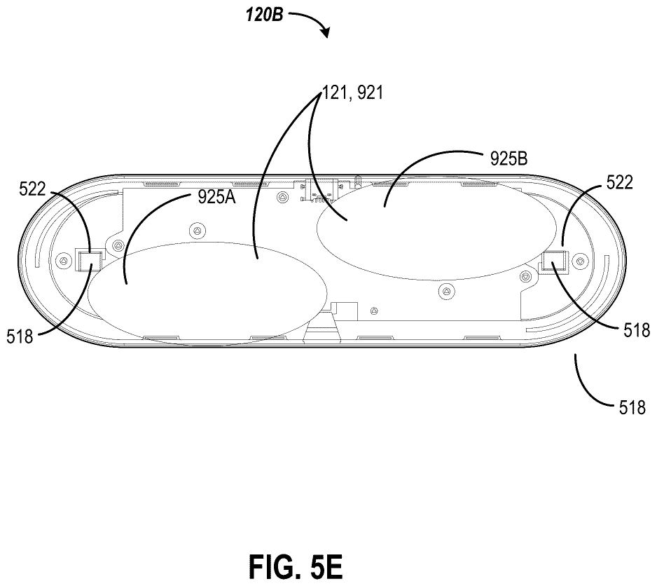

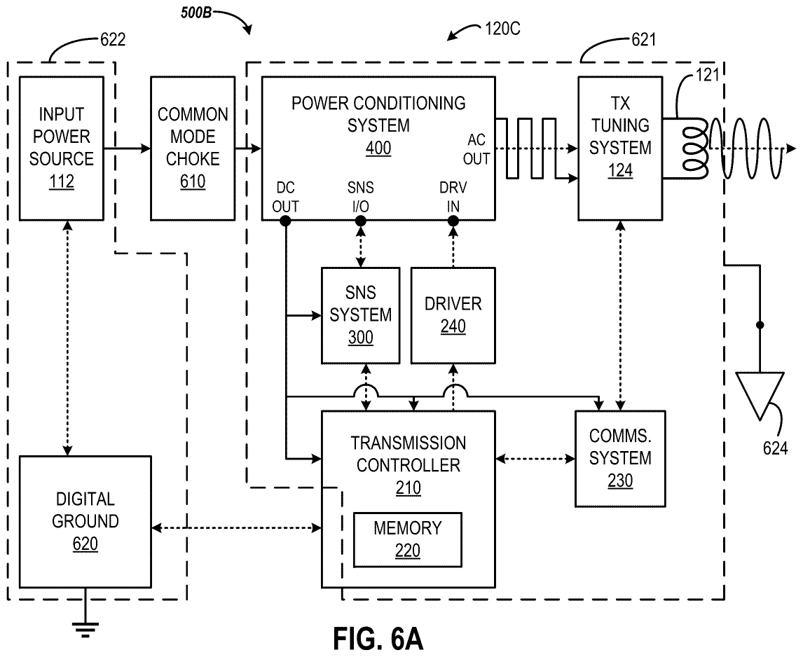

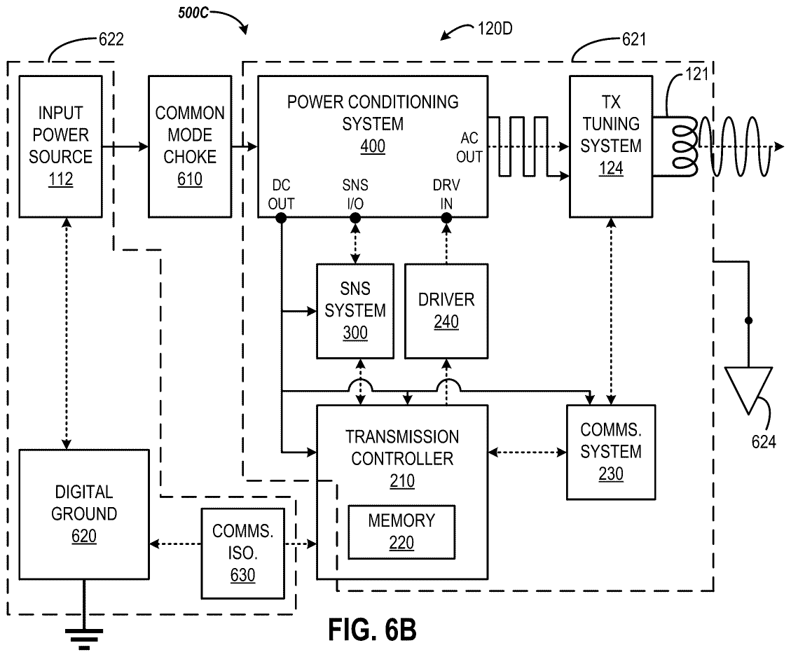

As will be discussed in more detail, below, the wireless transfer system 121 may include one or more EMI mitigation feature(s) 500. Examples of EMI mitigation features, as implemented as part of a wireless transmission system 120, are described below with respect to FIGS. 5A-6B.

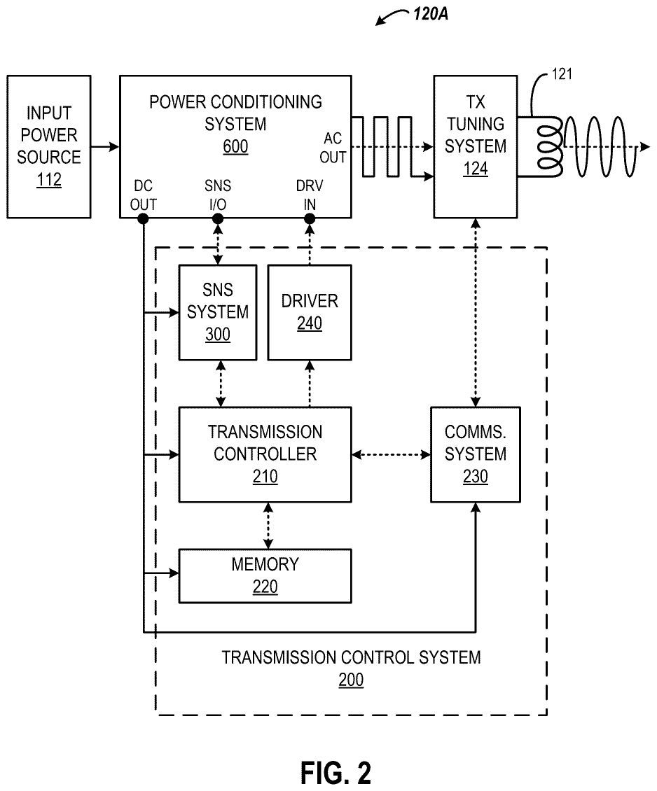

Referring now to FIG. 2, with continued reference to FIGS. 1A and 1B, subcomponents and/or systems of the transmission control system 200 are illustrated. The transmission control system 200 may include a sensing system 300, a transmission controller 210, a driver 240, and a memory 220.

The transmission controller 210 may be any electronic controller or computing system that includes, at least, a processor which performs operations, executes control algorithms, stores data, retrieves data, gathers data, controls and/or provides communication with other components and/or subsystems associated with the wireless transmission system 120, and/or performs any other computing or controlling task desired. The transmission controller 210 includes at least one processor, at least one machine-readable medium, and program instructions stored on the at least one machine-readable medium which, when executed by the at least one processor, cause the transmission controller 210 to perform any of the functions disclosed herein.

The transmission controller 210 may be a single controller or may include more than one controller disposed to control various functions and/or features of the wireless transmission system 120. Functionality of the transmission controller 210 may be implemented in hardware and/or software and may rely on one or more data maps relating to the operation of the wireless transmission system 120.

To that end, the transmission controller 210 may be operatively associated with the memory 220. The memory may include one or more of internal memory, external memory, and/or remote memory (e.g., a database and/or server operatively connected to the transmission controller 210 via a network, such as, but not limited to, the Internet), each of which may be examples of at least one non-transitory machine-readable medium. The internal memory and/or external memory may include, but are not limited to including, one or more of a read only memory (ROM), including programmable read-only memory (PROM), erasable programmable read-only memory (EPROM or sometimes but rarely labelled EROM), electrically erasable programmable read-only memory (EEPROM), random access memory (RAM), including dynamic RAM (DRAM), static RAM (SRAM), synchronous dynamic RAM (SDRAM), single data rate synchronous dynamic RAM (SDR SDRAM), double data rate synchronous dynamic RAM (DDR SDRAM, DDR2, DDR3, DDR4), graphics double data rate synchronous dynamic RAM (GDDR SDRAM, GDDR2, GDDR3, GDDR4, GDDR5, GDDR6), a flash memory, a portable memory, and the like. Such memory media are examples of non-transitory machine-readable and/or computer-readable memory media.

While particular elements of the transmission control system 200 are illustrated as independent components and/or circuits (e.g., the driver 240, the memory 220, the sensing system 300, among other contemplated elements) of the transmission control system 200, such components may be integrated with the transmission controller 210. In some examples, the transmission controller 210 may be an integrated circuit configured to include functional elements of one or more of the transmission controller 210 and/or other components of the wireless transmission system 120, generally.

Prior to providing data transmission and receipt details, it should be noted that either of the wireless transmission system 120 and the wireless receiver system 130 may send data to the other within the disclosed principles, regardless of which entity is wirelessly sending or wirelessly receiving power. As illustrated, the transmission controller 210 is in operative association, for the purposes of data transmission, receipt, and/or communication, with, at least, the memory 220, a communications system 230, the power conditioning system 600, the driver 240, and the sensing system 300.

The driver 240 may be implemented to control, at least in part, the operation of the power conditioning system 600. In some examples, the driver 240 may receive instructions from the transmission controller 210 to generate and/or output a generated pulse width modulation (PWM) signal to the power conditioning system 600. In some such examples, the PWM signal may be configured to drive the power conditioning system 600 to output electrical power as an alternating current signal, having an operating frequency defined by the PWM signal. In some examples, PWM signal may be configured to generate a duty cycle for the AC power signal output by the power conditioning system 600. In some such examples, the duty cycle may be configured to be about 50% of a given period of the AC power signal; however, the duty cycle is certainly not limited to being about 50% of a given period of the AC power signal.

The sensing system 300 may include one or more sensors, wherein each sensor may be operatively associated with one or more components of the wireless transmission system 120 and configured to provide information and/or data. The term “sensor” is used in its broadest interpretation to define one or more components operatively associated with the wireless transmission system 120 that operate to sense functions, conditions, electrical characteristics, operations, and/or operating characteristics of one or more of the wireless transmission system 120, the wireless receiving system 130, the input power source 112, the host device 110, the transmission antenna 121, the receiver antenna 151, along with any other components and/or subcomponents thereof. Again, while the examples may illustrate a certain configuration, it should be appreciated that either of the wireless transmission system 120 and the wireless receiver system 130 may send data to the other within the disclosed principles, regardless of which entity is wirelessly sending or wirelessly receiving power.

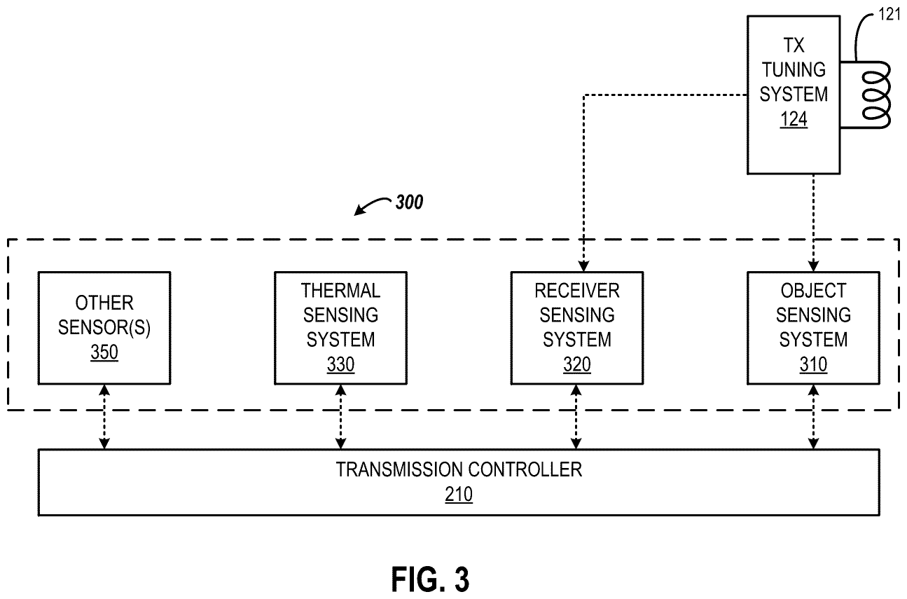

As illustrated in the embodiment of FIG. 3, the sensing system 300 may include, but is not limited to including, a thermal sensing system 330, an object sensing system 310, a receiver sensing system 320, a current sensor 340, and/or any other sensor(s) 350. Within these systems, there may exist even more specific optional additional or alternative sensing systems addressing particular sensing aspects required by an application, such as, but not limited to: a condition-based maintenance sensing system, a performance optimization sensing system, a state-of-charge sensing system, a temperature management sensing system, a component heating sensing system, an IoT sensing system, an energy and/or power management sensing system, an impact detection sensing system, an electrical status sensing system, a speed detection sensing system, a device health sensing system, among others. The object sensing system 310, may be a foreign object detection (FOD) system. The sensing system 300 may include other sensing components, as well.

Each of the thermal sensing system 330, the object sensing system 310, the receiver sensing system 320 and/or the other sensor(s) 350, including the optional additional or alternative systems, are operatively and/or communicatively connected to the transmission controller 210. The thermal sensing system 330 is configured to monitor ambient and/or component temperatures within the wireless transmission system 120 or other elements nearby the wireless transmission system 120. The thermal sensing system 330 may be configured to detect a temperature within the wireless transmission system 120 and, if the detected temperature exceeds a threshold temperature, the transmission controller 210 prevents the wireless transmission system 120 from operating. Such a threshold temperature may be configured for safety considerations, operational considerations, efficiency considerations, and/or any combinations thereof. In a non-limiting example, if, via input from the thermal sensing system 330, the transmission controller 210 determines that the temperature within the wireless transmission system 120 has increased from an acceptable operating temperature to an undesired operating temperature (e.g., in a non-limiting example, the internal temperature increasing from about 20° Celsius (C) to about 50° C., the transmission controller 210 prevents the operation of the wireless transmission system 120 and/or reduces levels of power output from the wireless transmission system 120. In some non-limiting examples, the thermal sensing system 330 may include one or more of a thermocouple, a thermistor, a negative temperature coefficient (NTC) resistor, a resistance temperature detector (RTD), and/or any combinations thereof.

As depicted in FIG. 3, the sensing system 300 may include the object sensing system 310. The object sensing system 310 may be configured to detect one or more of the wireless receiver system 150 and/or the receiver antenna 151, thus indicating to the transmission controller 210 that the receiver system 30 is proximate to the wireless transmission system 120. Additionally or alternatively, the object sensing system 310 may be configured to detect presence of unwanted objects in contact with or proximate to the wireless transmission system 120. In some examples, the object sensing system 310 is configured to detect the presence of an undesired object. In some such examples, if the transmission controller 210, via information provided by the object sensing system 310, detects the presence of an undesired object, then the transmission controller 210 prevents or otherwise modifies operation of the wireless transmission system 120. In some examples, the object sensing system 310 utilizes an impedance change detection scheme, in which the transmission controller 210 analyzes a change in electrical impedance observed by the transmission antenna 121 against a known, acceptable electrical impedance value or range of electrical impedance values.

Additionally or alternatively, the object sensing system 310 may utilize a quality factor (Q) change detection scheme, in which the transmission controller 210 analyzes a change from a known quality factor value or range of quality factor values of the object being detected, such as the receiver antenna 151. The “quality factor” or “Q” of an inductor can be defined as (frequency (Hz)×inductance (H))/resistance (ohms), where frequency is the operational frequency of the circuit, inductance is the inductance output of the inductor and resistance is the combination of the radiative and reactive resistances that are internal to the inductor. “Quality factor,” as defined herein, is generally accepted as an index (figure of measure) that measures the efficiency of an apparatus like an antenna, a circuit, or a resonator. In some examples, the object sensing system 310 may include one or more of an optical sensor, an electro-optical sensor, a Hall effect sensor, a proximity sensor, and/or any combinations thereof.

The receiver sensing system 320 is any sensor, circuit, and/or combinations thereof configured to detect presence of any wireless receiving system that may be couplable with the wireless transmission system 120. In some examples, the receiver sensing system 320 and the object sensing system 310 may be combined, may share components, and/or may be embodied by one or more common components. In some examples, if the presence of any such wireless receiving system is detected, wireless transmission of electrical energy, electrical power, electromagnetic energy, and/or data by the wireless transmission system 120 to said wireless receiving system is enabled. In some examples, if the presence of a wireless receiver system is not detected, continued wireless transmission of electrical energy, electrical power, electromagnetic energy, and/or data is prevented from occurring.

Accordingly, the receiver sensing system 320 may include one or more sensors and/or may be operatively associated with one or more sensors that are configured to analyze electrical characteristics within an environment of or proximate to the wireless transmission system 120 and, based on the electrical characteristics, determine presence of a wireless receiver system 150.

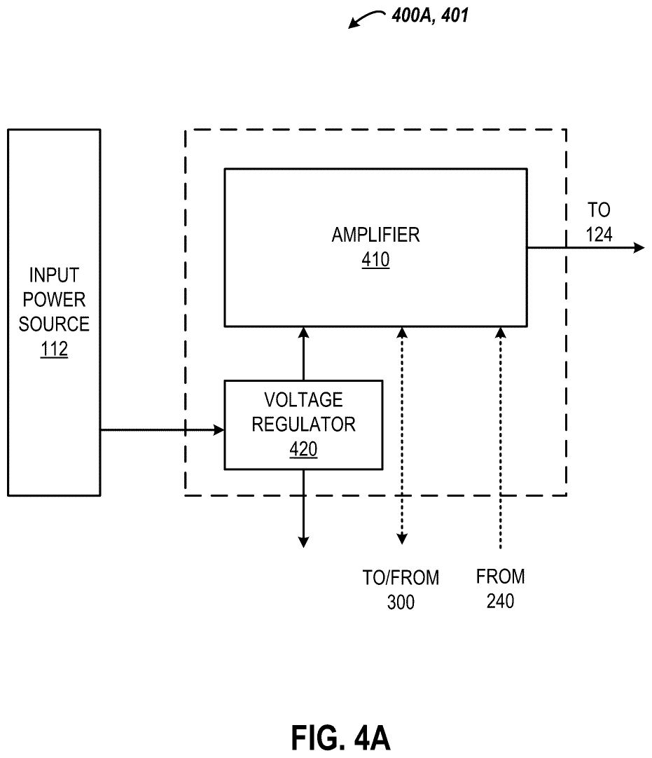

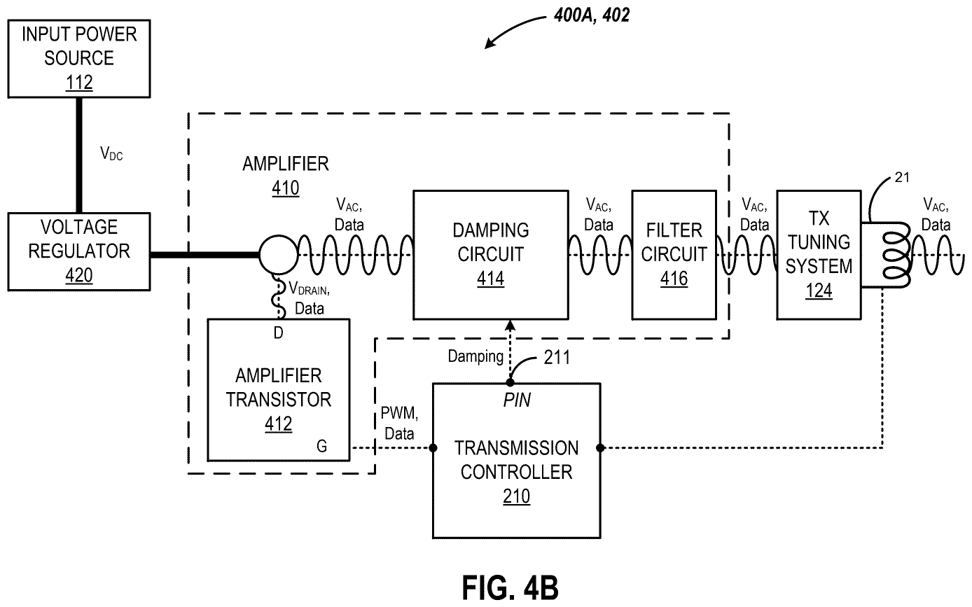

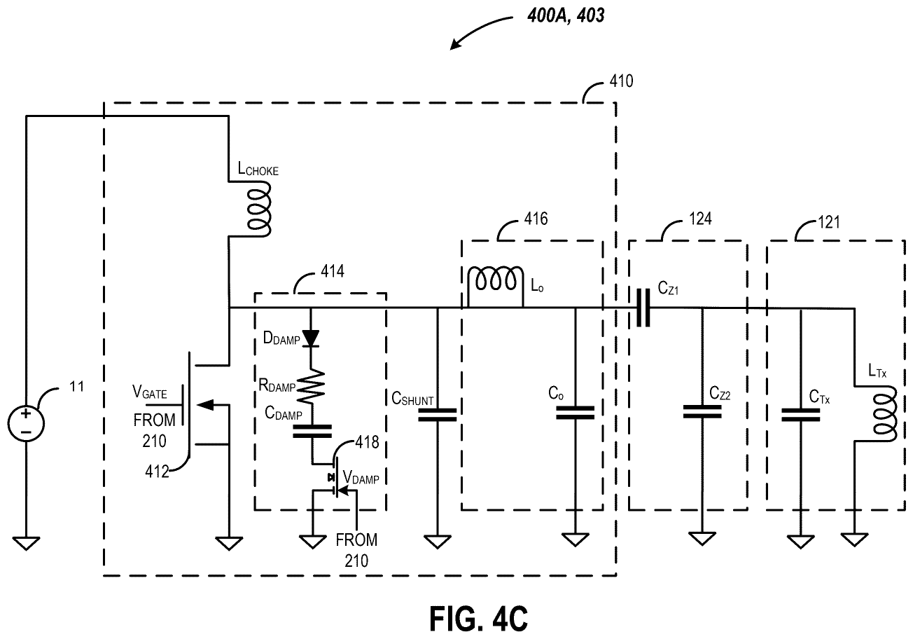

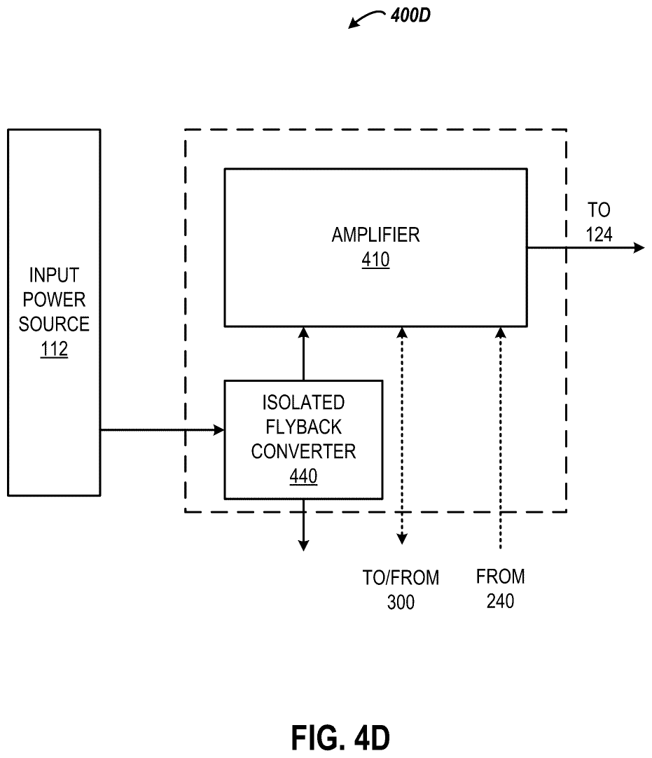

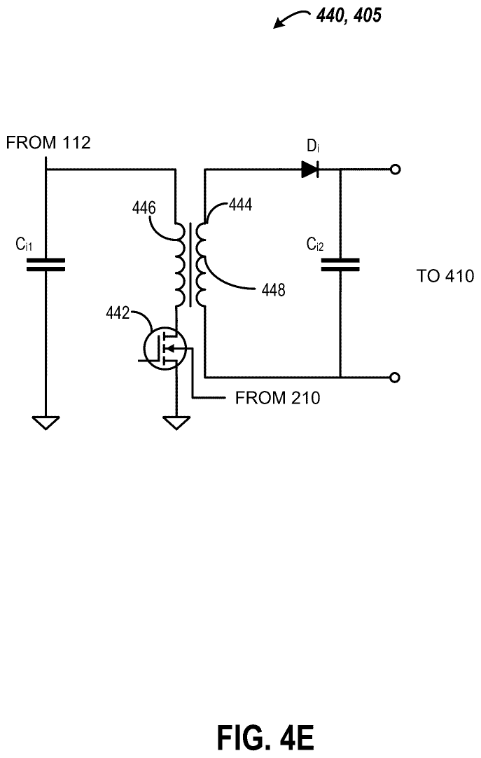

Referring now to FIG. 4A, and with continued reference to FIGS. 1-3, a block diagram illustrating an embodiment of a power conditioning system 400A is illustrated. At the power conditioning system 400A, electrical power is received, generally, as a DC power source, via the input power source 112 itself or an intervening power converter, converting an AC source to a DC source (not shown). A voltage regulator 420 receives the electrical power from the input power source 112 and is configured to provide electrical power for transmission by the transmission antenna 121 and provide electrical power for powering components of the wireless transmission system 120. Accordingly, the voltage regulator 420 is configured to convert the received electrical power into at least two electrical power signals, each at a proper voltage for operation of the respective downstream components: a first electrical power signal to electrically power any components of the wireless transmission system 120 and a second portion conditioned and modified for wireless transmission to the wireless receiver system 150. As illustrated in FIG. 4A, such a first portion is transmitted to, at least, the sensing system 300, the transmission controller 210 (e.g., via the driver 240), and/or the communications system 230; however, the first portion is not limited to transmission to just these components and can be transmitted to any electrical components of the wireless transmission system 120.

The second portion of the electrical power is provided to an amplifier 410 of the power conditioning system 400A, which is configured to condition the electrical power for wireless transmission by the transmission antenna 121. The amplifier 410 may function as an inverter, which receives an input DC power signal from the voltage regulator 420 and generates an AC signal as output, based, at least in part, on PWM input from the transmission controller 210. The amplifier 410 may be or include, for example, a power stage invertor, such as a dual field effect transistor power stage invertor or a quadruple field effect transistor power stage invertor. The use of the amplifier 410 within the power conditioning system 40 and, in turn, the wireless transmission system 120 enables wireless transmission of electrical signals having much greater amplitudes than if transmitted without such an amplifier. For example, the addition of the amplifier 410 may enable the wireless transmission system 120 to transmit electrical energy as an electrical power signal having electrical power from about 10 mW to about 500 W. In some examples, the amplifier 410 may be or may include one or more class-E power amplifiers. Class-E power amplifiers are efficiently tuned switching power amplifiers designed for use at high frequencies (e.g., frequencies from about 1 MHz to about 1 GHz). Generally, a class-E amplifier employs a single-pole switching element and a tuned reactive network between the switch and an output load (e.g., the transmission antenna 121). Class E amplifiers may achieve high efficiency at high frequencies by only operating the switching element at points of zero current (e.g., on-to-off switching) or zero voltage (off to on switching). Such switching characteristics may minimize power lost in the switch, even when the switching time of the device is long compared to the frequency of operation. However, the amplifier 410 is certainly not limited to being a class-E power amplifier and may be or may include one or more of a class D amplifier, a class EF amplifier, an H invertor amplifier, and/or a push-pull invertor, among other amplifiers that could be included as part of the amplifier 410.

Turning now to FIGS. 4B and 4C, the wireless transmission system 120 is illustrated, further detailing elements of the power conditioning system 400A, the amplifier 410, and the transmission tuning system 124, among other things. The block diagram 401, in FIG. 4B, of the wireless transmission system 120 illustrates one or more electrical signals and the conditioning of such signals, altering of such signals, transforming of such signals, inverting of such signals, amplification of such signals, and combinations thereof. In FIG. 4B, DC power signals are illustrated with heavily bolded lines, such that the lines are significantly thicker than other solid lines in FIG. 4B and other figures of the instant application, AC signals are illustrated as substantially sinusoidal wave forms with a thickness significantly less bolded than that of the DC power signal bolding, and data signals are represented as dotted lines. It is to be noted that the AC signals are not necessarily substantially sinusoidal waves and may be any AC waveform suitable for the purposes described below (e.g., a half sine wave, a square wave, a half square wave, among other waveforms). FIG. 4C illustrates an electrical schematic diagram 402 of example electrical components for elements of the wireless transmission system, and subcomponents thereof, in a simplified form. Note that FIG. 4C may represent one branch or sub-section of a schematic for the wireless transmission system 120 and/or components of the wireless transmission system 120 may be omitted from the schematic illustrated in FIG. 4C for clarity.

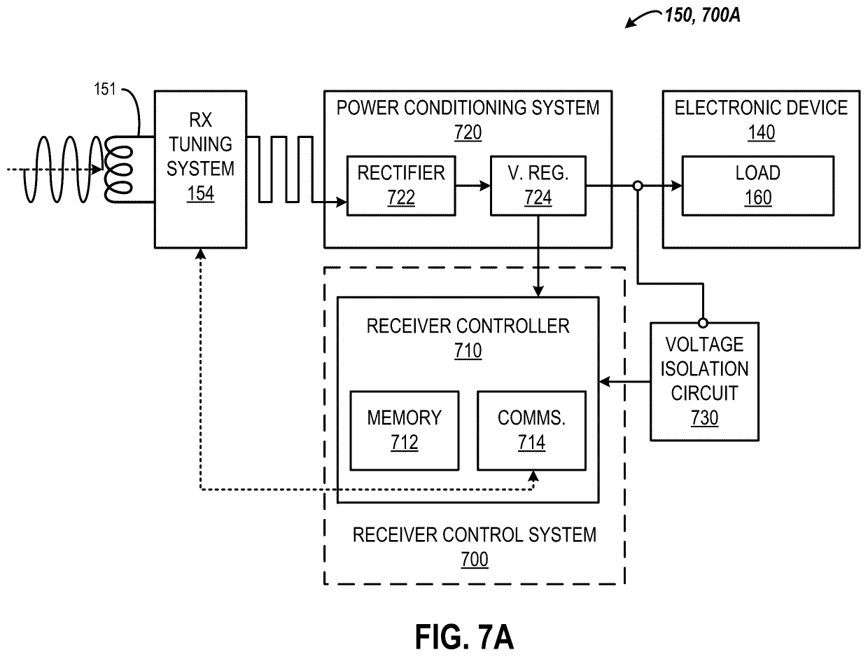

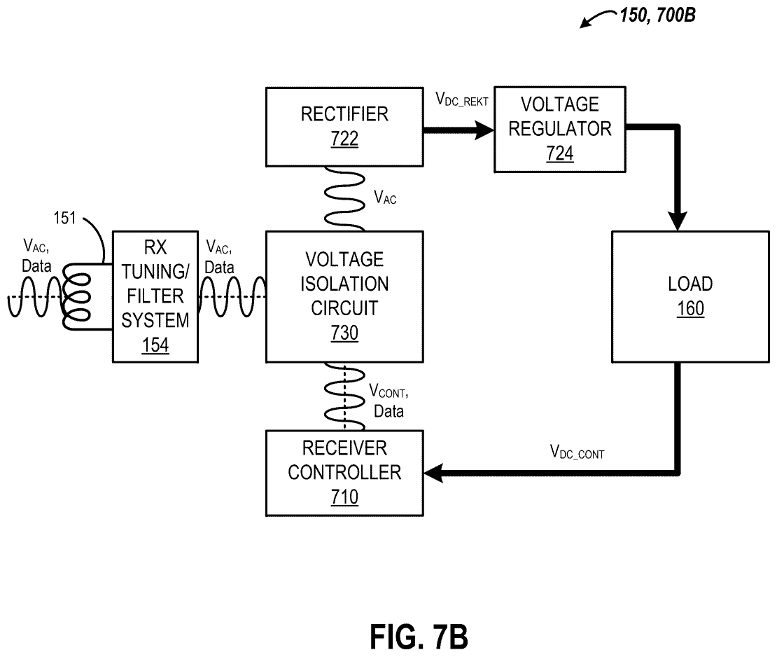

As illustrated in FIG. 4B and discussed above, the input power source 112 provides an input direct current voltage (V_{DC}), which may have its voltage level altered by the voltage regulator 420, prior to conditioning at the amplifier 410. In some examples, as illustrated in FIG. 7, the amplifier 410 may include a choke inductor L_{CHOKE}, which may be utilized to block radio frequency interference in V_{DC}, while allowing the DC power signal of V_{DC} to continue towards an amplifier transistor 68 of the amplifier 410. V_{CHOKE} may be configured as any suitable choke inductor known in the art.

The amplifier 410 is configured to alter and/or invert V_{DC} to generate an AC wireless signal VAC, which, as discussed in more detail below, may be configured to carry one or both of an inbound and outbound data signal (denoted as “Data” in FIG. 4B). The amplifier transistor 412 may be any switching transistor known in the art that is capable of inverting, converting, and/or conditioning a DC power signal into an AC power signal, such as, but not limited to, a field-effect transistor (FET), gallium nitride (GaN) FETS, bipolar junction transistor (BJT), and/or wide-bandgap (WBG) semiconductor transistor, among other known switching transistors. The amplifier transistor 412 is configured to receive a driving signal (denoted as “PWM” in FIG. 4B) from at a gate of the amplifier transistor 68 (denoted as “G” in FIG. 4B) and invert the DC signal V_{DC} to generate the AC wireless signal at an operating frequency and/or an operating frequency band for the wireless transmission system 120. The driving signal may be a PWM signal configured for such inversion at the operating frequency and/or operating frequency band for the wireless transmission system 120.

The driving signal is generated and output by the transmission control system 200 and/or the transmission controller 210 therein, as discussed and disclosed above. The transmission controller 210 is configured to provide the driving signal and configured to perform one or more of encoding wireless data signals (denoted as “Data” in FIG. 4B), decoding the wireless data signals (denoted as “Data” in FIG. 4B) and any combinations thereof. In some examples, the electrical data signals may be in band signals of the AC wireless power signal. In some such examples, such in-band signals may be on-off-keying (OOK) signals in-band of the AC wireless power signals. For example, Type-A communications, as described in the NFC Standards, are a form of OOK, wherein the data signal is on-off-keyed in a carrier AC wireless power signal operating at an operating frequency in a range of about 13.553 MHz to about 13.567 MHz.

However, when the power, current, impedance, phase, and/or voltage levels of an AC power signal are changed beyond the levels used in current and/or legacy hardware for high frequency wireless power transfer (over about 500 mW transmitted), such legacy hardware may not be able to properly encode and/or decode in-band data signals with the required fidelity for communications functions. Such higher power in an AC output power signal may cause signal degradation due to increasing rise times for an OOK rise, increasing fall time for an OOK fall, overshooting the required voltage in an OOK rise, and/or undershooting the voltage in an OOK fall, among other potential degradations to the signal due to legacy hardware being ill equipped for higher power, high frequency wireless power transfer. Thus, there is a need for the amplifier 410 to be designed in a way that limits and/or substantially removes rise and fall times, overshoots, undershoots, and/or other signal deficiencies from an in-band data signal during wireless power transfer. This ability to limit and/or substantially remove such deficiencies allows for the systems of the instant application to provide higher power wireless power transfer in high frequency wireless power transmission systems.

To achieve limitation and/or substantial removal of the mentioned deficiencies, the amplifier 410 includes a damping circuit 414. The damping circuit 414 is configured for damping the AC wireless signal during transmission of the AC wireless signal and associated data signals. The damping circuit 414 may be configured to reduce rise and fall times during OOK signal transmission, such that the rate of the data signals may not only be compliant and/or legible, but may also achieve faster data rates and/or enhanced data ranges, when compared to legacy systems. For damping the AC wireless power signal, the damping circuit includes, at least, a damping transistor 418, which is configured for receiving a damping signal (V_{damp}) from the transmission controller 210. The damping signal is configured for switching the damping transistor (on/off) to control damping of the AC wireless signal during the transmission and/or receipt of wireless data signals. Such transmission of the AC wireless signals may be performed by the transmission controller 210 and/or such transmission may be via transmission from the wireless receiver system 150, within the coupled magnetic field between the antennas 121, 151.

In examples wherein the data signals are conveyed via OOK, the damping signal may be substantially opposite and/or an inverse to the state of the data signals. This means that if the OOK data signals are in an “on” state, the damping signals instruct the damping transistor to turn “off” and thus the signal is not dissipated via the damping circuit 414 because the damping circuit is not set to ground and, thus, a short from the amplifier circuit and the current substantially bypasses the damping circuit 414. If the OOK data signals are in an “off” state, then the damping signals may be “on” and, thus, the damping transistor 418 is set to an “on” state and the current flowing of VAC is damped by the damping circuit. Thus, when “on,” the damping circuit 414 may be configured to dissipate just enough power, current, and/or voltage, such that efficiency in the system is not substantially affected and such dissipation decreases rise and/or fall times in the OOK signal. Further, because the damping signal may instruct the damping transistor 418 to turn “off” when the OOK signal is “on,” then it will not unnecessarily damp the signal, thus mitigating any efficiency losses from VAC, when damping is not needed. While depicted as utilizing OOK coding, other forms of in band coding may be utilized for coding the data signals, such as, but not limited to, amplitude shift keying (ASK).

As illustrated in FIG. 4B, the branch of the amplifier 410 which may include the damping circuit 414, is positioned at the output drain of the amplifier transistor 418. While it is not necessary that the damping circuit 414 be positioned here, in some examples, this may aid in properly damping the output AC wireless signal, as it will be able to damp at the node closest to the amplifier transistor 68 output drain, which is the first node in the circuit wherein energy dissipation is desired. In such examples, the damping circuit is in electrical parallel connection with a drain of the amplifier transistor 418. However, it is certainly possible that the damping circuit be connected proximate to the transmission antenna 121, proximate to the transmission tuning system 124, and/or proximate to a filter circuit 416.

While the damping circuit 414 is capable of functioning to properly damp the AC wireless signal for proper communications at higher power high frequency wireless power transmission, in some examples, the damping circuit may include additional components. For instance, as illustrated, the damping circuit 414 may include one or more of a damping diode D_{DAMP}, a damping resistor R_{DAMP}, a damping capacitor C_{DAMP}, and/or any combinations thereof. R_{DAMP} may be in electrical series with the damping transistor 418 and the value of R_{DAMP} (ohms) may be configured such that it dissipates at least some power from the power signal, which may serve to accelerate rise and fall times in an amplitude shift keying signal, an OOK signal, and/or combinations thereof. In some examples, the value of R_{DAMP} is selected, configured, and/or designed such that R_{DAMP} dissipates the minimum amount of power to achieve the fastest rise and/or fall times in an in-band signal allowable and/or satisfy standards limitations for minimum rise and/or fall times; thereby achieving data fidelity at maximum efficiency (less power lost to R_{DAMP}) as well as maintaining data fidelity when the system is unloaded and/or under lightest load conditions.

C_{DAMP} may also be in series connection with one or both of the damping transistor 418 and R_{DAMP}. C_{DAMP} may be configured to smooth out transition points in an in-band signal and limit overshoot and/or undershoot conditions in such a signal. Further, in some examples, C_{DAMP} may be configured for ensuring the damping performed is 180 degrees out of phase with the AC wireless power signal, when the transistor is activated via the damping signal.

D_{DAMP} may further be included in series with one or more of the damping transistor 418, R_{DAMP}, C_{DAMP}, and/or any combinations thereof. D_{DAMP} is positioned, as shown, such that a current cannot flow out of the damping circuit 414, when the damping transistor 418 is in an off state. The inclusion of D_{DAMP} may prevent power efficiency loss in the AC power signal when the damping circuit is not active or “on.” Indeed, while the damping transistor 418 is designed such that, in an ideal scenario, it serves to effectively short the damping circuit when in an “off” state, in practical terms, some current may still reach the damping circuit and/or some current may possibly flow in the opposite direction out of the damping circuit 414. Thus, inclusion of D_{DAMP} may prevent such scenarios and only allow current, power, and/or voltage to be dissipated towards the damping transistor 418. This configuration, including D_{DAMP}, may be desirable when the damping circuit 414 is connected at the drain node of the amplifier transistor 68, as the signal may be a half-wave sine wave voltage and, thus, the voltage of V_{AC} is always positive.

Beyond the damping circuit 414, the amplifier 410, in some examples, may include a shunt capacitor C_{SHUNT}. C_{SHUNT} may be configured to shunt the AC power signal to ground and charge voltage of the AC power signal. Thus, C_{SHUNT} may be configured to maintain an efficient and stable waveform for the AC power signal, such that a duty cycle of about 50% is maintained and/or such that the shape of the AC power signal is substantially sinusoidal at positive voltages.

In some examples, the amplifier 410 may include a filter circuit 416. The filter circuit 416 may be designed to mitigate and/or filter out electromagnetic interference (EMI) within the wireless transmission system 120. Design of the filter circuit 416 may be performed in view of impedance transfer and/or effects on the impedance transfer of the wireless transmission system 120 due to alterations in tuning made by the transmission tuning system 124. To that end, the filter circuit 416 may be or include one or more of a low pass filter, a high pass filter, and/or a band pass filter, among other filter circuits that are configured for, at least, mitigating EMI in a wireless power transmission system.

As illustrated, the filter circuit 416 may include a filter inductor Lₒ and a filter capacitor Cₒ. The filter circuit 416 may have a complex impedance and, thus, a resistance through the filter circuit 416 may be defined as Rₒ. In some such examples, the filter circuit 416 may be designed and/or configured for optimization based on, at least, a filter quality factor γ_{FILTER}, defined as:

$${γ}_{FILTER} = \frac{1}{{R}_{o}} \sqrt{\frac{{L}_{o}}{{C}_{o}}} .$$

In a filter circuit 416 wherein it includes or is embodied by a low pass filter, the cut-off frequency (ωₒ) of the low pass filter is defined as:

$${ω}_{o} = \frac{1}{\sqrt{{L}_{o} {C}_{o}}} .$$

In some wireless power transmission systems 20, it is desired that the cutoff frequency be about 1.03-1.4 times greater than the operating frequency of the antenna. Experimental results have determined that, in general, a larger γ_{FILTER} may be preferred, because the larger γ_{FILTER} can improve voltage gain and improve system voltage ripple and timing. Thus, the above values for Lₒ and Cₒ may be set such that γ_{FILTER} can be optimized to its highest, ideal level (e.g., when the system 100 impedance is conjugately matched for maximum power transfer), given cutoff frequency restraints and available components for the values of Lₒ and Cₒ.

As illustrated in FIG. 4B, the conditioned signal(s) from the amplifier 410 is then received by the transmission tuning system 124, prior to transmission by the transmission antenna 121. The transmission tuning system 124 may include tuning and/or impedance matching, filters (e.g. a low pass filter, a high pass filter, a “pi” or “Π” filter, a “T” filter, an “L” filter, a “LL” filter, and/or an L-C trap filter, among other filters), network matching, sensing, and/or conditioning elements configured to optimize wireless transfer of signals from the wireless transmission system 120 to the wireless receiver system 150. Further, the transmission tuning system 124 may include an impedance matching circuit, which is designed to match impedance with a corresponding wireless receiver system 150 for given power, current, and/or voltage requirements for wireless transmission of one or more of electrical energy, electrical power, electromagnetic energy, and electronic data. The illustrated transmission tuning system 124 includes, at least, C_{Z1}, C_{Z2}. and (operatively associated with the transmission antenna 121) values, all of which may be configured for impedance matching in one or both of the wireless transmission system 120 and the broader system 10. It is noted that C_{Tx} refers to the intrinsic capacitance of the transmission antenna 121.

Turning now to FIG. 4D, another example of a power conditioning system 400D for use with the wireless transmission system 120 is illustrated. The power conditioning system 400D may include various common components to those of the power conditioning system 400D and, accordingly, said components are similarly labelled (e.g., the amplifier 410, etc.). Further, the power conditioning system 400D includes an isolated flyback converter 440.

An isolated flyback converter, generally, is an electrical circuit capable of receiving electrical power at a first voltage and converting the first voltage to a second voltage, while isolating the input power source of the isolated flyback converter from downstream components of the wireless transmission system 120. To that end, an isolated flyback converter may be utilized in DC to DC power conversion, but with galvanic isolation between the input power and the output power. Galvanic isolation is a principle of isolating functional sections of electrical systems to prevent current flow and, thus, no direct conduction path is permitted between the input to an isolated flyback converter and the output of an isolated flyback converter.

Turning to FIG. 4E, an example schematic diagram 405 for an example implementation of the isolated flyback converter 440 is illustrated. As illustrated, the isolated flyback converter 440 may include a flyback transistor 442, a transformer 444, two or more capacitors (Cᵢ₁, Cᵢ₂), and a diode (Dᵢ). The flyback transistor 442 receives input power at a first voltage from the input power source 112 and converts the input power to a second power at a second voltage.

The flyback transistor 442 operates as a switch, opening and closing a current loop between Cᵢ₁, the input power source 112, and the flyback transistor 442. When the flyback transistor 442 operates as a closed switch, a primary inductor 446 of the transformer 444 is directly connected to the input power source 112. In this position, the primary current and magnetic flux in the transformer 444 increases, storing energy in the transformer 444. In this position, the voltage induced in a secondary inductor 448 of the transformer 444 is a negative voltage, so Dᵢ is reversed biased and Cᵢ₂ provides output from the isolated flyback converter 440. When the flyback transistor 442 operates as open, the primary current and magnetic flux drops in the transformer 444, so the secondary voltage at the secondary inductor 448 is now positive, forward-biasing Dᵢ and allowing current to flow from the transformer. The energy from the transformer 444 then also charges Cᵢ and supplies power output from the isolated flyback converter 440.

Thus, the isolated flyback converter 440 may be utilized to replace a conventional voltage regulator (e.g., a buck converter, a boost converter, a buck-boost converter) with a form of voltage regulation that isolates the input power source 112 from downstream components of the wireless transmission system 120. To that end, the isolated flyback converter 440 may reduce EMI noise by not allowing a feedback path for conducted emissions from one or more components of the wireless transmission system 120 that may be susceptible to such noise, due to switching elements (e.g., the amplifier 410).

Turning now to FIG. 5A, an example block diagram for another wireless transmission system 120B is illustrated. The wireless transmission system 120B may include various common components to those of the wireless transmission system 120B and, accordingly, said components are similarly labelled (e.g., transmission antenna 121, the transmission tuning system 124, the transmission controller 210, the memory 220, the communications system 230, the driver 240, the sensing system 300, the power conditioning system 400, etc.). Further, the wireless transmission system 120B includes a first EMI mitigation feature 500A, in the form of a single-point grounding strategy.

The single-point grounding strategy involves determining a location on a circuit to insert a single point connected to a chassis ground source, with which most, if not all, connections to ground in the wireless transmission system 120B are to be connected. The single-point grounding strategy may utilize a single-point grounded conductor 510 that is connected to a single point in the circuit, with which most, if not all, of the connections to ground are electrically connected.

The single-point grounded conductor 510 may be a form of chassis ground that grounds most, if not all, of the ground connections of various components of the wireless transmission system 120. A chassis ground may refer to a link between grounded components sources and conductive parts (e.g., a metal plate) to ensure an electrical connection between them. While the term “chassis ground” implies that this conductor be the actual chassis of a device, it need not be the chassis and can be any substantial conductive material that is part of the device. The chassis ground may take various other forms and/or may include various other components (e.g., a conductive screw that connects to the PCB, a conductive thermal pad attached to the PCB, a think conductive plate associated with the PCB, etc.).

To that end, turning now to FIGS. 5B and 5C, exploded and bottom views, respectively, of an example implementation of the wireless transmission system 120B are illustrated. As illustrated, the wireless transmission system 120 includes a single-point grounded conductor 510, which may take the form of a conductive plate 510A. Such a conductive plate 510A may be formed from any conductive metal (e.g., copper, aluminum, steel, nickel, etc.) suitable for acting as a chassis ground for the wireless transmission system 120B. As illustrated, one or more components of the wireless transmission system 120B may be affixed to a substrate 516.

The conductive plate 510A may also be connected to the substrate 516 at a single-point grounding point 513, wherein the single-point grounding point 513 is electrically connected to ground connections of components of the wireless transmission system 120B (e.g., the transmission control system 200, the power conditioning system 400, the sensing system 300, the transmission tuning system 124, the antenna 121, etc.).

However, while electrically connected to the single-point grounding point 513, the conductive plate 510A is electrically separated from all electrical components of the wireless transmission system 120, other than the single-point grounding point 513. To that end, as illustrated, the wireless transmission system 120B may include one or more standoffs 518 that are configured to separate the conductive plate 510A from any electrical contacts of the wireless transmission system 120B, other than the single-point grounding point.

In a non-limiting example, the single-point grounding point 513 may be positioned proximate to a connector that receives input from an input power source (e.g., the input power source 112). By positioning the single-point grounding point 513 proximate to this connector, the single-point grounding point may mitigate feedback (e.g., EMI noise) from feeding back on the connector.

The conductive plate 510A and the single-point grounding point 513 may be connected to one another via an electro-mechanical connector 517 that is configured for electrically and mechanically connecting the single-point grounding point and the conductive plate. To that end, the electro-mechanical connector 517 may be, for example, an electro-mechanical screw. However, the electro-mechanical connector 517 may take various other forms, as well.

In some examples, and as illustrated, the conductive plate 510A may define one or more connector cutouts 514 that are figured to connect the conductive plate 510A to another mechanical body associated with the wireless transmission system 120 (e.g., a chassis, a housing, etc.). However, said connector cutouts 514 are not intended to provide a means for connection of the conductive plate 510A to the substrate 516.

Turning now to FIG. 5D and with continued reference to FIGS. 5A-C, a bottom view of another example conductive plate 510B for use with the wireless transmission system 120B is illustrated. The conductive plate 510B may include various common components to those of the conductive plate 510A and, accordingly, said components are similarly labelled (e.g., the single-point grounding point 513, the connector cutouts 514, the electro-mechanical connector 517, etc.). Additionally, the conductive plate 510B may define one or more slits 520 that are strategically positioned on the conductive plate 510B and extend radially inward from a perimeter of the conductive plate 510B.

The slits 520 may be configured to break or separate two points on the perimeter of the conductive plate 510B, such that when an eddy current is induced in the conductive plate 510B during operations of the wireless transmission system 120B, such an eddy current's direction is reversed and does not oppose the direction of the field generated by the wireless transmission system 120B. In some examples, the slits 520 may be configured such that they allow magnetic fields to propagate through the conductive plate 510B, without losses, while still capturing E-field noise. These slits may provide a lower impedance path for such E-field noise to travel to the chassis ground (rather than to a ground reference plane).

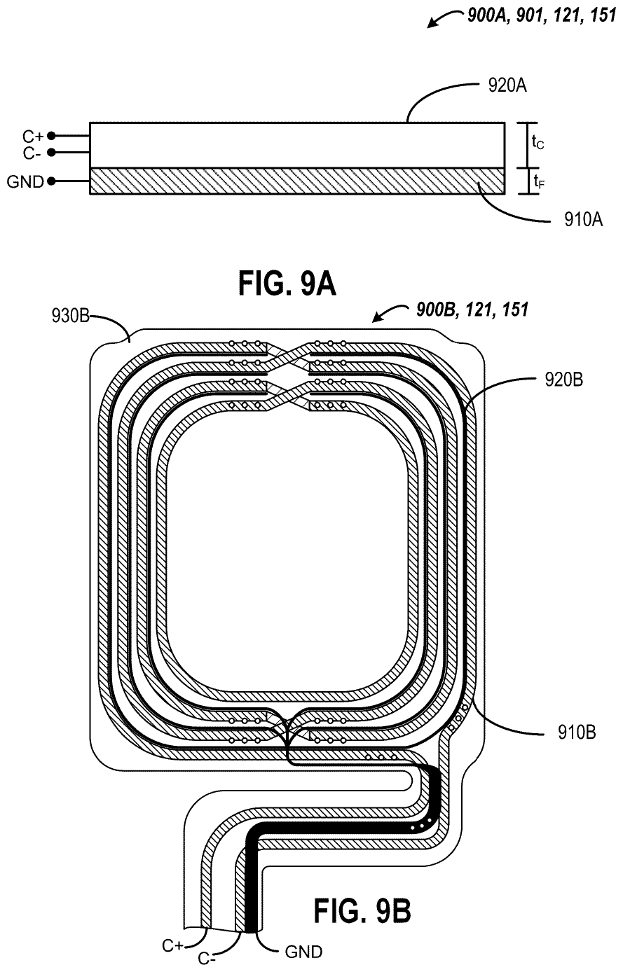

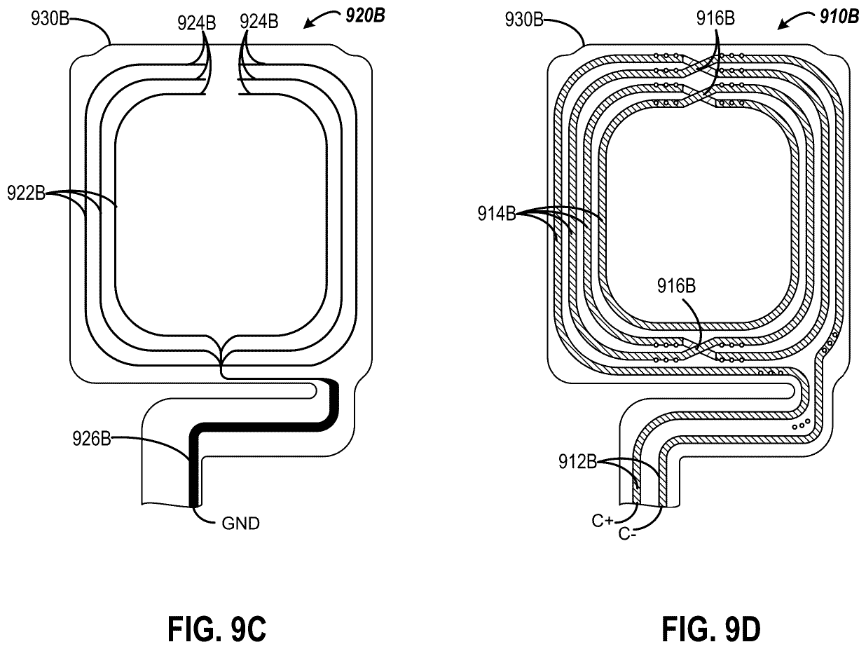

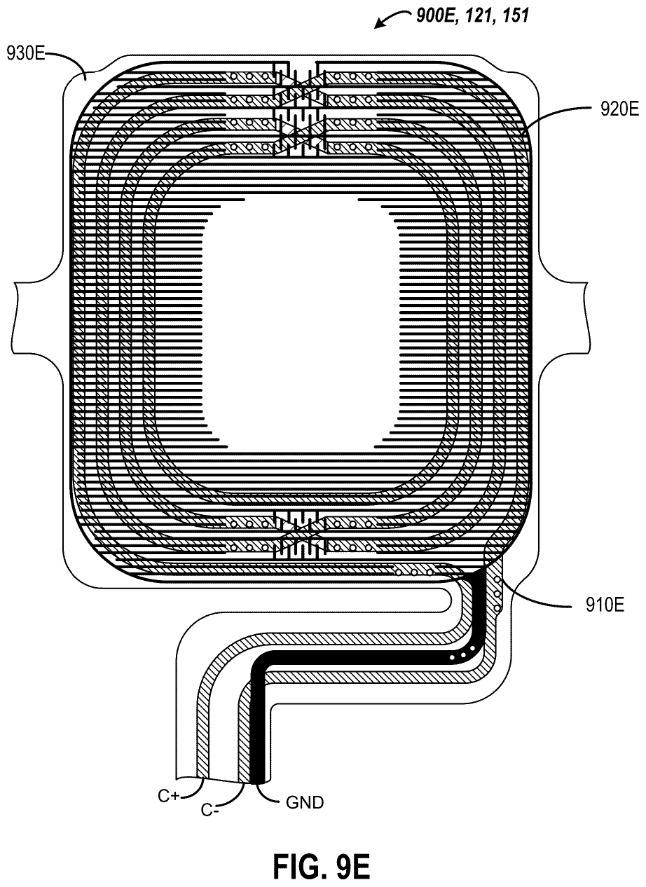

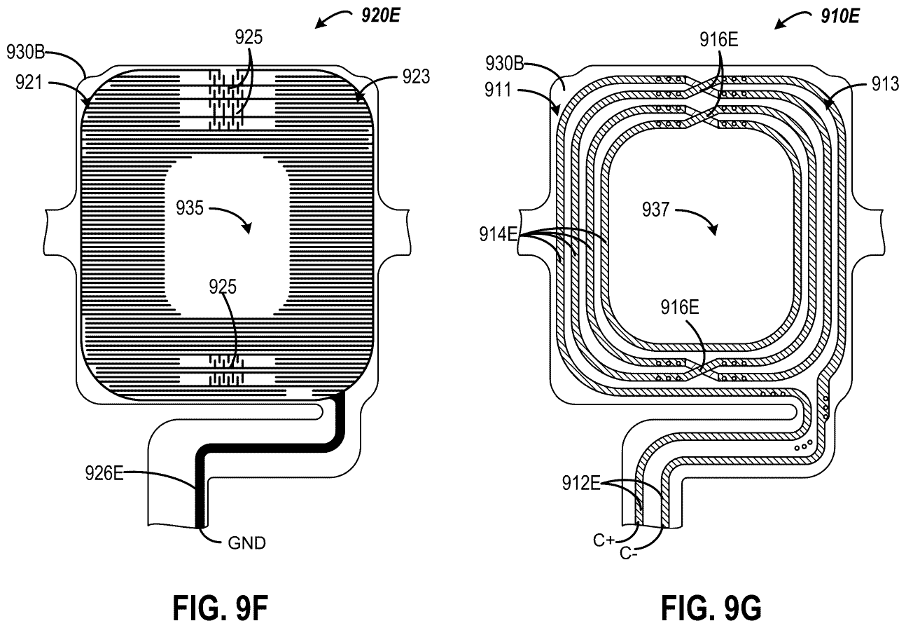

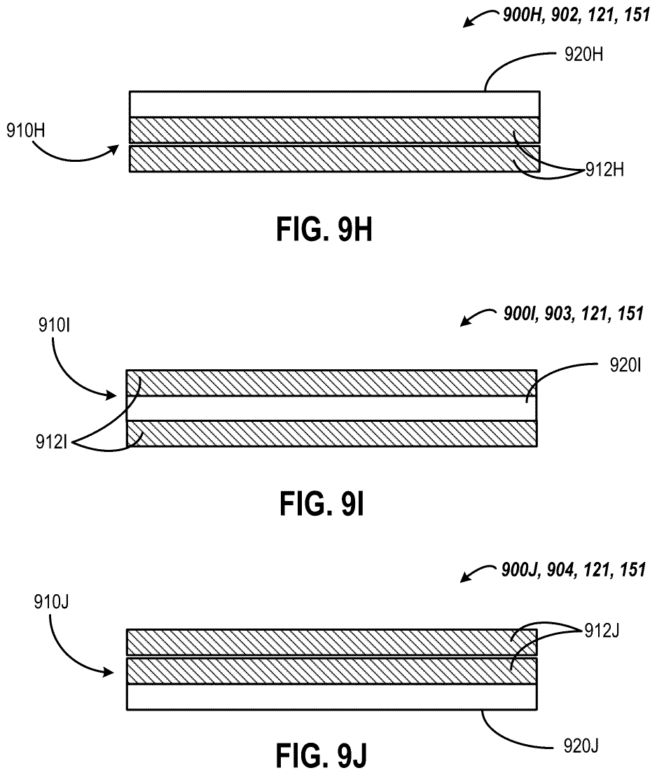

In some examples, the transmission antenna 121 may be a multi-zone antenna (e.g., those discussed below with respect to FIGS. 9A, 9B). In such examples, the slits 520 may include a first slit 524 and a second slit 526. Each of the first slit 524 and the second slit 526 may be positioned such that, when fully assembled, the slits will be proximate to where respective portions (e.g., first and second antenna portions 925A, 925B) of the multi-zone antenna are located in a stack up of the wireless transmission system 120B. Thus, any eddy currents induced by said portions of the multi-zone antenna are minimized while the E-fields are still captured, thus increasing capacitive coupling and reducing EMI.

In some examples, such as the second slit 526, a slit 520 may include additional geometric features, such as hatching pattern of the second slit 526. By utilizing additional cut out of materials that are strategically positioned based on the stack up of the end product for the wireless transmission system 120, additional benefits may be had. For example, the hatching pattern of the second slit 526 may be configured to reside below the substrate 516 in the stack up and has an effect of reducing electrical-field (E-field) propagation from components affixed to the substrate 516.

To that end, the second slit 526 may be configured to provide the functionality of a filter for reducing the E-Field propagation from components affixed to the substrate 516. For example, the second slit 526 may be configured as a comb filter that is strategically positioned under said components affixed to the substrate 516 and configured to reduce E-field propagation from said components. A comb-filter may be a filter that is implemented by adding a delayed version of a signal to itself, which causes constructive and destructive interference—this may take the form of either feedforward or feedback forms of frequency-response based filtering.

Turning now to FIG. 5E and with continued reference to FIGS. 5A-D, a top cutaway view of the wireless transmission system 120B is illustrated. In this view, magnets 522 can be seen proximate to the standoffs 518. The magnets 522 may be configured to magnetically connect with magnets of an opposing polarity that are associated with a device that includes a wireless receiver system 150 that receives power from the wireless transmission system 120B. In such an example, the magnets 522 have a pull force that is configured to attract the opposing magnets associated with the wireless receiver system 150.

In such examples and with continued reference to FIG. 5D, the single-point grounded conductor 510 may be configured to have a weight that is configured to offset the pull force, such that when a user attempts to separate the device associated with the wireless receiver system 150, he/she/they do not also pick up the wireless transmission system 120B, due to it's magnetic connection via the magnets 522. For example, consider that the device associated with the wireless receiver system 150 are smart glasses that are configured to be charged via the wireless transmission system 120B. In such examples, if the wireless transmission system 120B is not heavy enough to offset the pull force of the magnets 522, then the user will pick up the wireless transmission system 120B with the smart glasses. Accordingly, the wireless transmission system 120B must be of adequate weight to mitigate this issue, for the purposes of user experience.

To that end, the single-point grounded conductor 510 may be configured with a sizeable weight that is configured to, at least, offset the pull force of the magnets 522. In such examples, the weight of the single-point grounded conductor 510 may be further refined for user experience by utilizing a plurality of weight cutouts 523 (FIG. 5D) to finely refine the weight of the wireless transmission system 120B.

Turning now to FIG. 6A, an example block diagram for another wireless transmission system 120C is illustrated. The wireless transmission system 120C may include various common components to those of the wireless transmission system(s) 120 and, accordingly, said components are similarly labelled (e.g., transmission antenna 121, the transmission tuning system 124, the transmission controller 210, the memory 220, the communications system 230, the driver 240, the sensing system 300, the power conditioning system 400, etc.). Further, the wireless transmission system 120C includes a common mode choke 610 and a second EMI mitigation feature 500B, in the form of a first dual-grounding configuration utilizing, at least, a digital ground circuit 620.

A first component for mitigating EMI noise is the common mode choke 610. The common mode choke 610 may refer to an inductor that is used to block higher-frequency AC current signals, while passing DC currents in a circuit. More specifically, a common mode choke 610 may refer to an application of a choke that acts upon a common-mode signal and, thus is useful in mitigating EMI noise fed back to, for example, the input power source 112.

While useful in mitigating EMI noise, the common mode choke 610 may not provide all the mitigation needed to pass certification. To that end, a second EMI mitigation feature 500B is illustrated and applied to the wireless transmission system 120C. The second EMI mitigation feature 500B may comprise a split grounding strategy, wherein a first group of components 621 are connected to ground via an analog ground 624 and a second group of components and connectors 622 are connected to ground via a digital ground circuit 620.

Analog and digital ground may both refer to a reference point in an electrical circuit; however, they may serve different purposes. Analog ground may be used in analog circuits and is meant to provide a stable reference point for voltage in analog signals, which may be important for maintaining accuracy in analog measurements and for reducing noise in analog circuits. Conversely, digital ground is used for digital circuit elements and is designed to provide a reference point for digital signals, thus it is used to maintain digital references (e.g., high and low) for ensuring transmitted signals are accurately interpreted.

By separating components of the wireless transmission system 120C into analog-grounded components and digital-grounded components, EMI noise feedback on an input power source can be mitigated, so long as the input power source's communications channels are communicating with digitally grounded components. To that end, the second group of components and connectors 622 are connected to the digital ground circuit 620 and are, thus, isolated, from a reference perspective, from the analog-grounded components. As illustrated, the second group of components includes the input power source 112 (e.g., a communications component of a USB input/output controller) and one or more connectors or pins of the transmission controller 210.

The digital ground circuit 620 may be any circuit, be it discrete component based or an integrated circuit, that digitally grounds the components of the second group of components and connectors 622. Any component that is not part of the input, generation, conversion, sensing, output, or demodulation of the wireless transmission system 120 can be included in the digital ground. Examples of these components are microcontrollers, memory ICs, USB enumeration ICs, DC sensing circuitry, or any other peripheral functionality of the system. Microcontrollers that have capabilities to generate, demodulate, modulate, convert, sense, rectify or regulate the wireless power AC signal but also have other functionalities like system control, peripheral control, USB enumeration, or any other that does not involve the direct manipulation of the Wireless power signal may have split grounds within the chip itself. Typically, these type of ICs have different ground pinouts of their sub-blocks (i.e. host interfaces, power clocks, PMUs, timers, are all sub-blocks of a particular IC). This functionality can be exploited to separate the ground to minimize the coupling of the noisy/dirty ground with the clean digital ground.

Turning now to FIG. 6B, an example block diagram for another wireless transmission system 120D is illustrated. The wireless transmission system 120D may include various common components to those of the wireless transmission system(s) 120 and, accordingly, said components are similarly labelled (e.g., transmission antenna 121, the transmission tuning system 124, the transmission controller 210, the memory 220, the communications system 230, the driver 240, the sensing system 300, the power conditioning system 400, etc.). Further, the wireless transmission system 120D includes another EMI mitigation feature 500C, in the form of a second dual-grounding configuration utilizing, at least, a digital ground circuit 620 and a communications isolation circuit 630.

The communications isolation circuit 630 may be any circuit, be it discrete component based or an integrated circuit, that communicatively isolates the components of the second group of components and connectors 622 from the first group of components 621. For example, the communications isolation circuit 630 may be a bidirectional Inter-Integrated Circuit (I2C) isolator, which may enable reliable bidirectional data transfer with high-noise immunity. Thus, the communications isolation circuit 630 may further reduce EMI noise feedback to the input power source 112.

Turning now to FIG. 7A and with continued reference to, at least, FIGS. 1-2, the wireless receiver system 150 is illustrated in further detail in a block diagram 700A. The wireless receiver system 150 is configured to receive, at least, electrical energy, electrical power, electromagnetic energy, and/or electrically transmittable data, via near field magnetic coupling from the wireless transmission system 120, via the transmission antenna 121. As illustrated in FIG. 7, the wireless receiver system 150 includes, at least, the receiver antenna 151, a receiver tuning system 154, a power conditioning system 720, a receiver control system 700, and a voltage isolation circuit 730. The receiver tuning system 154 may be configured to substantially match the electrical impedance of the wireless transmission system 120. In some examples, the receiver tuning system 154 may be configured to dynamically adjust and substantially match the electrical impedance of the receiver antenna 151 to a characteristic impedance of the power generator or the load at a driving frequency of the transmission antenna 121.

As illustrated, the power conditioning system 720 includes a rectifier 722 and a voltage regulator 724. In some examples, the rectifier 722 is in electrical connection with the receiver tuning system 154. The rectifier 722 is configured to convert the received electrical energy from an alternating current electrical energy signal to a direct current electrical energy signal. In some examples, the rectifier 722 is comprised of at least one diode. Some non-limiting example configurations for the rectifier 722 include, but are not limited to including, a full wave rectifier, a center tapped full wave rectifier, a full wave rectifier with filter, a half wave rectifier, a half wave rectifier with filter, a bridge rectifier, a bridge rectifier with filter, a split supply rectifier, a single phase rectifier, a three phase rectifier, a voltage doubler, a synchronous voltage rectifier, a controlled rectifier, an uncontrolled rectifier, a half controlled rectifier, and the like. As electronic devices may be sensitive to voltage, additional protection of the electronic device may be provided by clipper circuits or devices. In this respect, the rectifier 722 may further include a clipper circuit or a clipper device, which is a circuit or device that removes either the positive half (top half), the negative half (bottom half), or both the positive and the negative halves of an input AC signal. In other words, a clipper is a circuit or device that limits the positive amplitude, the negative amplitude, or both the positive and the negative amplitudes of the input AC signal. The rectifier 722 may also have circuitry to prevent over voltage conditions, these circuits may include Zener diodes, transistors, mechanical switches, among other things.

Of course, other example implementations, including additional or alternative components for the rectifier 722, are contemplated, as well.

Some non-limiting examples of a voltage regulator 724 include, but are not limited to, including a series linear voltage regulator, a buck convertor, a low dropout (LDO) regulator, a shunt linear voltage regulator, a step up switching voltage regulator, a step down switching voltage regulator, an invertor voltage regulator, a Zener controlled transistor series voltage regulator, a charge pump regulator, and an emitter follower voltage regulator. The voltage regulator 724 may further include a voltage multiplier, which is as an electronic circuit or device that delivers an output voltage having an amplitude (peak value) that is, for example, two, three, or more times greater than the amplitude (peak value) of the input voltage. The voltage regulator 724 is in electrical connection with the rectifier 722 and configured to adjust the amplitude of the electrical voltage of the wirelessly received electrical energy signal, after conversion to AC by the rectifier 722. In some examples, the voltage regulator 724 may include a LDO linear voltage regulator; however, other voltage regulation circuits and/or systems are contemplated. As illustrated, the direct current electrical energy signal output by the voltage regulator 724 is received at the load 1600 of the electronic device 140. In some examples, a portion of the direct current electrical power signal may be utilized to power the receiver control system 700 and any components thereof; however, it is certainly possible that the receiver control system 700, and any components thereof, may be powered and/or receive signals from the load 1600 (e.g., when the load 1600 is a battery and/or other power source) and/or other components of the electronic device 140.

The receiver control system 700 may include, but is not limited to including, a receiver controller 710, a communications system 714, and a memory 712.

The receiver controller 710 may be any electronic controller or computing system that includes, at least, a processor which performs operations, executes control algorithms, stores data, retrieves data, gathers data, controls and/or provides communication with other components and/or subsystems associated with the wireless receiver system 150. The transmission controller 210 includes at least one processor, at least one machine-readable medium, and program instructions stored on the at least one machine-readable medium which, when executed by the at least one processor, cause the transmission controller 210 to perform any of the functions disclosed herein. The receiver controller 710 may be a single controller or may include more than one controller disposed to control various functions and/or features of the wireless receiver system 150.

Functionality of the receiver controller 710 may be implemented in hardware and/or software and may rely on one or more data maps relating to the operation of the wireless receiver system 150. To that end, the receiver controller 710 may be operatively associated with the memory 712. The memory 712 may include one or both of internal memory, external memory, and/or remote memory (e.g., a database and/or server operatively connected to the receiver controller 710 via a network, such as, but not limited to, the Internet). The internal memory and/or external memory may include, but are not limited to including, one or more of a read only memory (ROM), including programmable read-only memory (PROM), erasable programmable read-only memory (EPROM or sometimes but rarely labelled EROM), electrically erasable programmable read-only memory (EEPROM), random access memory (RAM), including dynamic RAM (DRAM), static RAM (SRAM), synchronous dynamic RAM (SDRAM), single data rate synchronous dynamic RAM (SDR SDRAM), double data rate synchronous dynamic RAM (DDR SDRAM, DDR2, DDR3, DDR4), and graphics double data rate synchronous dynamic RAM (GDDR SDRAM, GDDR2, GDDR3, GDDR4, GDDR5, a flash memory, a portable memory, and the like. Such memory media are examples of non-transitory computer and/or machine readable memory media.

Further, while particular elements of the receiver control system 700 are illustrated as subcomponents and/or circuits (e.g., the memory 712, the communications system 714, among other contemplated elements) of the receiver control system 700, such components may be external of the receiver controller 710. In some examples, the receiver controller 710 may be and/or include one or more integrated circuits configured to include functional elements of one or both of the receiver controller 710 and the wireless receiver system 150, generally. As used herein, the term “integrated circuits” generally refers to a circuit in which all or some of the circuit elements are inseparably associated and electrically interconnected so that it is considered to be indivisible for the purposes of construction and commerce. Such integrated circuits may include, but are not limited to including, thin-film transistors, thick-film technologies, and/or hybrid integrated circuits.

In some examples, the receiver controller 710 may be a dedicated circuit configured to send and receive data at a given operating frequency. For example, the receiver controller 710 may be a tagging or identifier integrated circuit, such as, but not limited to, an NFC tag and/or labelling integrated circuit. Examples of such NFC tags and/or labelling integrated circuits include the NTAG® family of integrated circuits manufactured by NXP Semiconductors N.V. However, the communications system 39 is certainly not limited to these example components and, in some examples, the communications system 39 may be implemented with another integrated circuit (e.g., integrated with the receiver controller 710), and/or may be another transceiver of or operatively associated with one or both of the electronic device 14 and the wireless receiver system 150, among other contemplated communication systems and/or apparatus. Further, in some examples, functions of the communications system 39 may be integrated with the receiver controller 710, such that the controller modifies the inductive field between the antennas 121, 151 to communicate in the frequency band of wireless power transfer operating frequency.

The communications system 714 may be any circuit, instructions, and/or functionality that can be utilized in conjunction with the receiver controller 710 to modulate and/or demodulate data signals that are encoded in the wireless power transfer, with the wireless power transfer acting as a carrier signal for the modulated/demodulated signals. For example, the communications system 714 may be configured to modulate the power signal between antennas 121, 151 to encode data signals in-band of the power signals in accordance with the aforementioned pulse width encoding schemes discussed above. Additionally or alternatively, the communications system 714 may include circuits, systems, and/or functionality for demodulating data signals in band of the power signals between the antennas 121, 151. Of course, the communications system 714 may take other forms, for demodulating and/or modulating a power signal in accordance with encoded/decoded signals, as well.

Turning now to FIG. 7B, the wireless receiver system 150 is illustrated in further detail to show some example functionality of one or more of the receiver controller 710, the voltage isolation circuit 730, and the rectifier 722. The block diagram of the wireless receiver system 150 illustrates one or more electrical signals and the conditioning of such signals, altering of such signals, transforming of such signals, rectifying of such signals, amplification of such signals, and combinations thereof. Similarly to FIG. 4B, DC power signals are illustrated with heavily bolded lines, such that the lines are significantly thicker than other solid lines in FIG. 4B and other figures of the instant application, AC signals are illustrated as substantially sinusoidal wave forms with a thickness significantly less bolded than that of the DC power signal bolding, and data signals are represented as dotted lines.

As illustrated in FIG. 7B, the receiver antenna 151 receives the AC wireless signal, which includes the AC power signal (V_{AC}) and the data signals (denoted as “Data” in FIG. 7B), from the transmission antenna 121 of the wireless transmission system 120. V_{AC} will be received at the rectifier 722 and/or the broader power conditioning system 32, wherein the AC wireless power signal is converted to a DC wireless power signal (V_{DC_REKT}). V_{DC_REKT} is then provided to, at least, the load 160 that is operatively associated with the wireless receiver system 150. In some examples, V_{DC_REKT} is regulated by the voltage regulator 35 and provided as a DC input voltage (V_{DC_CONT}) for the receiver controller 710. In some examples, such as the signal path shown in FIGS. 7B, the receiver controller 710 may be directly powered by the load 160. In some other examples, the receiver controller 710 need not be powered by the load 160 and/or receipt of V_{DC_CONT}, but the receiver controller 710 may harness, capture, and/or store power from V_{AC}, as power receipt occurring in receiving, decoding, and/or otherwise detecting the data signals in-band of V_{AC}.

As illustrated in FIGS. 7A, 7B, the receiver controller 710 is configured to perform one or more of encoding the wireless data signals, decoding the wireless data signals, receiving the wireless data signals, transmitting the wireless data signals, and/or any combinations thereof. In examples wherein the data signals are encoded and/or decoded as ASK signals and/or OOK signals, the receiver controller 710 may receive and/or otherwise detect or monitor voltage levels of V_{AC} to detect in-band ASK and/or OOK signals. However, at higher power levels than those currently utilized in standard high frequency, NFMI communications and/or low power wireless power transmission, large voltages and/or large voltage swings at the input of a controller, such as the controller 710, may be too large for legacy microprocessor controllers to handle without disfunction or damage being done to such microcontrollers. Additionally, certain microcontrollers may only be operable at certain operating voltage ranges and, thus, when high frequency wireless power transfer occurs, the voltage swings at the input to such microcontrollers may be out of range or too wide of a range for consistent operation of the microcontroller.

For example, in some high frequency higher power wireless power transfer systems 100, when an output power from the wireless transmission system 120 is greater than 1 W, voltage across the controller 710 may be higher than desired for the controller 710. Higher voltage, lower current configurations are often desirable, as such configurations may generate lower thermal losses and/or lower generated heat in the system 10, in comparison to a high current, low voltage transmission. To that end, the load 160 may not be a consistent load, meaning that the resistance and/or impedance at the load 160 may swing drastically during, before, and/or after an instance of wireless power transfer.

This is particularly an issue when the load 160 is a battery or other power storing device, as a fully charged battery has a much higher resistance than a fully depleted battery. For the purposes of this illustrative discussion, we will assume:

$${V}_{AC \_ MIN} = {I}_{AC \_ MIN} * {R}_{LOAD \_ MIN} , and$$

$${P}_{AC \_ MIN} = {I}_{A C} * {V}_{LOAD \_ MIN} = {( {I}_{AC \_ MIN} )}^{2} * {R}_{LOAD \_ MIN}$$

wherein R_{LOAD_MIN} is the minimum resistance of the load 160 (e.g., if the load 160 is or includes a battery, when the battery of the load 160 is depleted), I_{AC_MIN} is the current at R_{LOAD_MIN}, V_{AC_MIN} is the voltage of V_{AC} when the load 160 is at its minimum resistance and P_{AC_MIN} is the optimal power level for the load 160 at its minimal resistance. Further, we will assume:

$${V}_{AC \_ MAX} = {I}_{AC \_ MAX} * {R}_{LOAD \_ MAX} , and$$

$${P}_{AC \_ MAX} = {I}_{AC \_ MAX} * {V}_{LOAD \_ MAX} = {( {I}_{AC \_ MAX} )}^{2} * {R}_{LOAD \_ MAX}$$

wherein R_{LOAD_MAX} is the maximum resistance of the load 160 (e.g., if the load 160 is or includes a battery, when the battery of the load 160 is depleted), I_{AC_MAX} is the current at V_{AC_MAX}, V_{AC_MAX} is the voltage of V_{AC} when the load 160 is at its minimum resistance and P_{AC_MAX} is the optimal power level for the load 160 at its maximal resistance.

Accordingly, as the current is desired to stay relatively low, the inverse relationship between I_{AC} and V_{AC} dictate that the voltage range must naturally shift, in higher ranges, with the change of resistance at the load 160.

However, such voltage shifts may be unacceptable for proper function of the controller 710. To mitigate these issues, the voltage isolation circuit 730 is included to isolate the range of voltages that can be seen at a data input and/or output of the controller 710 to an isolated controller voltage (V_{CONT}), which is a scaled version of V_{AC} and, thus, comparably scales any voltage-based in-band data input and/or output at the controller 710. Accordingly, if a range for the AC wireless signal that is an acceptable input range for the controller 710 is represented by

$${V}_{A C} = [ {V}_{AC \_ MIN} : {V}_{AC \_ MAX} ]$$

then the voltage isolation circuit 730 is configured to isolate the controller-unacceptable voltage range from the controller 710, by setting an impedance transformation to minimize the voltage swing and provide the controller with a scaled version of V_{AC}, which does not substantially alter the data signal at receipt. Such a scaled controller voltage, based on V_{AC}, is V_{CONT}, where

$${V}_{CONT} = [ {V}_{CONT \_ MIN} : {V}_{CONT \_ MAX} ] .$$

While an altering load is one possible reason that an unacceptable voltage swing may occur at a data input of a controller, there may be other physical, electrical, and/or mechanical characteristics and/or phenomena that may affect voltage swings in V_{AC}, such as, but not limited to, changes in coupling (k) between the antennas 121, 151, detuning of the system(s) 100, 120, 150 due to foreign objects, proximity of another receiver system 30 within a common field area, among other things.

The wireless receiver system 150, utilizing the voltage isolation circuit 730, may have the capability to achieve proper data communications fidelity at greater receipt power levels at the load 160, when compared to other high frequency wireless power transmission systems. To that end, the wireless receiver system 150, with the voltage isolation circuit 730, is capable of receiving power from the wireless transmission system that has an output power at levels over 1 W of power, whereas legacy high frequency systems may be limited to receipt from output levels of only less than 1 W of power. For example, in legacy NFC-DC systems, the listener (receiver system) often utilizes a microprocessor from the NTAG family of microprocessors, which was initially designed for very low power data communications. NTAG microprocessors, without protection or isolation, may not adequately and/or efficiently receive wireless power signals at output levels over 1 W. However, inventors of the present application have found, in experimental results, that when utilizing voltage isolation circuits as disclosed herein, the NTAG chip may be utilized and/or retrofitted for wireless power transfer and wireless communications, either independently or simultaneously.

To that end, the voltage isolation circuits disclosed herein may utilize inexpensive components (e.g., isolation capacitors) to modify functionality of legacy, inexpensive microprocessors (e.g., an NTAG family microprocessor), for new uses and/or improved functionality. Further, while alternative controllers may be used as the receiver controller 710 that may be more capable of receipt at higher voltage levels and/or voltage swings, such controllers may be cost prohibitive, in comparison to legacy controllers. Accordingly, the systems and methods herein allow for use of less costly components, for high power high frequency wireless power transfer.

Further description and examples of such isolation circuits are further disclosed in U.S. Pat. No. 11,469,626 to Peralta, et. al., titled “Wireless Power Receiver for Receiving High Power High Frequency Transfer,” which is commonly owned by applicant and incorporated by reference herein in its entirety.

Returning to FIG. 7A, in some example embodiments of the wireless receiver system 150, the wireless receiver system 150 may include functionality as an NFMI polling system, as discussed in more detail above. In such examples, the receiver controller 710 of the wireless receiver system 150 may further include a driver (similar to the driver of the wireless transmission system 120), and a communications system 714 (which may include one or both of a communications demodulator and a communications modulator. While described or illustrated as part of or integrated with the receiver controller 710, it is certainly possible that one or more components and/or functions of such a driver or the communications system 714 may be embodied by or functionally executed by other devices, hardware, or software, such as, but not limited to additional controllers or processors associated with the receiver controller 710, additional discrete components in electrical connection with the receiver controller 710, instructions stored on machine-readable media associated with the receiver controller 710, among other components external to the receiver controller 710.

As illustrated, the communications system 714 may be electrically connected, via a data receipt signal path, to one or more of the receiver tuning system 154, the receiver antenna 151, or combinations thereof, such that the communications system 714 can detect variances in a carrier signal (e.g., a wireless power signal, a polling signal, etc.) and subsequently determine or demodulate said variances to decode signals in-band of the aforementioned carrier signal. The communications system 714 may be electrically connected, via a data transmit signal path, to one or more of the receiver tuning system 154, the receiver antenna 151, or combinations thereof, such that the communications modulator can selectively alter a carrier signal (e.g., a wireless power signal, a polling signal, etc.) and subsequently insert said variances to encode signals in-band of the aforementioned carrier signal.

To that end, while the drawing and description of FIGS. 7A and 7B, above, generally refers to functions of the wireless receiver system 150 and components thereof in a wireless power receiver mode, FIGS. 7A and 7B are exemplary of a system capable of a polling operating mode for the wireless receiver system 150.

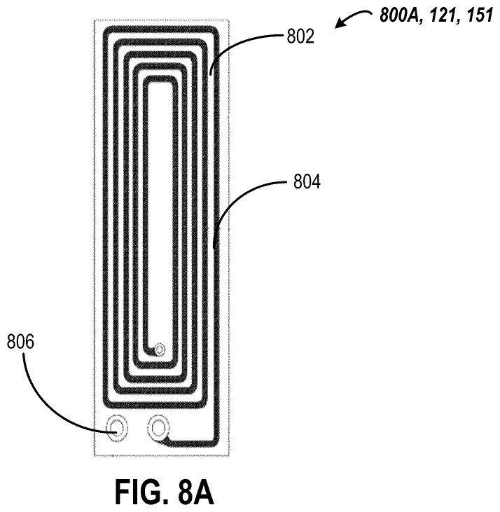

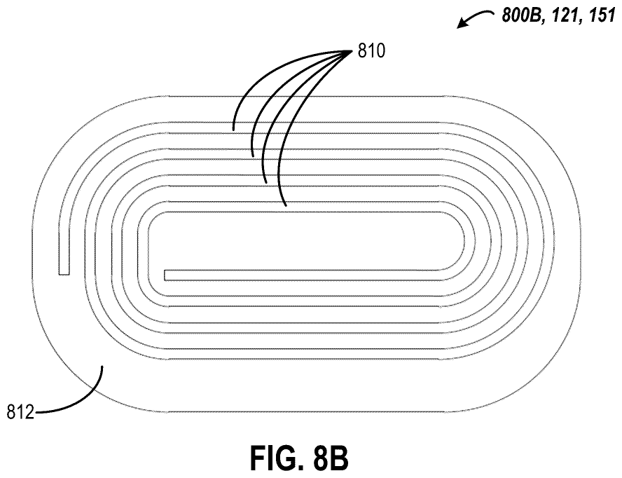

FIG. 8A illustrates an example, non-limiting embodiment of one or more of a first antenna 800A, which may be utilized as the transmission antenna 121, the receiver antenna 151, or any other antennas or coils discussed herein. The antenna 800A may be used with any of the systems, methods, and/or apparatus disclosed herein. In the illustrated embodiment, the antenna 800A is a flat spiral coil configuration.

The antenna 800A may be a printed circuit board (PCB) or flexible printed circuit board (FPC) antenna, having a plurality of turns 804 of a conductor and one or more connectors 806, all disposed on a substrate 802 of the antenna 800A. While the antenna 800A is illustrated, in FIG. 8A, having a certain number of turns and/or layers, the PCB or FPC antenna may include any number of turns or layers. The PCB or FPC antenna 800A of FIG. 8A may be produced via any known method of manufacturing PCB or FPCs known to those skilled in the art.

In another embodiment of an antenna 800B, illustrated in FIG. 8B, which may be utilized as the antenna 121, the antenna 151, or any other antenna disclosed herein, may be a wire wound antenna, wherein the antenna is a conductive wire wound in a particular pattern and having any number of turns 810. The wire wound antenna 800B may be free standing within an associated structure or, in some examples, the wire wound antenna 800B may be either held in place or positioned using a wire holder 812.

Of course, other examples for implementation of the transmission antenna 121 and/or the receiver antenna 151 are contemplated, as well.

As discussed above, an antenna for wireless power transmission (e.g., a transmission antenna 121, a receiver antenna 151, etc.) may include a filter layer for EMI filtering (e.g., for filtering common-mode noise that is emitted from the antenna). This may be particularly useful for inclusion in a wireless transmission antenna 121.

The filter layer functions to (i) intercept unwanted emissions propagated by the coil of the antenna and (ii) electrically route the unwanted emissions emitted by the coil of the antenna to a ground associated with the system in which the antenna is used (e.g., a wireless transmission system 120, a wireless receiver system 150, etc.). Intercepting the unwanted emission may take the form of capturing common mode noise (and associated harmonic content) of an E-field emitted by the coil, rather than (absent the filter layer) allowing the harmonic content (among other unwanted emissions) to propagate either through the air or through conductors to other electronic devices and/or other components of the system (e.g., a cable associated with the system). Thus, the unwanted emissions are routed to a lower impedance path than the path the emissions would take to earth ground and, as signals are attracted to the path of least resistance (e.g., impedance), this will cause the emissions to be routed to the shortest ground path possible, rather than to an earth ground through the air.

The filter layer may be configured to optimize one or more performance characteristics of the respective system within which the antenna (having the filter layer) is used. For example, consider that the antenna having the filter layer is used as part of a wireless transmission system 120. In this example (among others), the filter layer may be configured to optimize one or more performance characteristics for the wireless transmission system 120 (and the wireless power transfer that will be performed using the wireless transmission system 120), while still having a filter capacitance (CF) sufficient for filtering out EMI to a degree that is acceptable (either for passing regulatory requirements or for performance reasons). For example, such optimization of performance characteristics may include one or more of (i) optimizing for inductance of the antenna having the filter layer, (ii) optimizing for a minimal equivalent series resistance (ESR), (iii) optimizing for a self resonating frequency for the antenna that is less than some guidepost (e.g., less than three times the operating frequency of the system), (iv) optimizing for E-field location during wireless power transfer, (v) optimizing physical design of the filter layer such that it does not capture significant amounts of the magnetic field that is intended to couple with a receiver antenna, (vi) optimizing the physical design such that conductive material absorbs electric field proximate to coil layer such that the filter layer reduces electric flux induced by the coil layer within a given area proximate to the antenna, among other optimizations of performance characteristics.

In a practical sense, consider that the filter layer, effectively, creates a plate for a parallel plate capacitor, in which a coil layer of the antenna is another plate. In this example, consider that the filter layer can be configured, at least in part, based on values for variables that affect capacitance for a parallel plate capacitor. To that end, the CF, when considered as a capacitance of a parallel plate capacitor, may, at least in part, be configured such that

$${C}_{F} = \frac{ε A}{D}$$

where ε is the electrostatic constant, A is an area of conductive material of the filter layer that overlaps with conductive material of the coil layer of the antenna, and D is the separation distance between the filter layer and the coil layer. For the purposes of this discussion, consider that ε and D are, relatively, static values during the design process, as ε is a constant and D may be defined based on manufacturing tolerances for a PCB antenna. For example, D may be relatively constant for a given process of manufacturing a PCB antenna and may comprise a thickness of an insulating layer that is present between the filter layer and the coil layer.

Electric flux of an E-field emitted from the coil layer of an antenna may also contribute to EMI emissions from the system (with which the antenna is used). Accordingly, design of the filter layer may be optimized to reduce the electric flux of an emitted E-field, within a given area proximate to the antenna. Designing for reduction in electric flux may involve specific positioning the conductive materials of the filter layer proximate (in a stack-up sense) to areas of the coil layer wherein greater electric flux magnitudes are observed.

Further, C_{F} may be configured with electric flux (φ_{E}) of an emitted E-field in mind. Consider that C_{F} may be defined in terms of (i) a voltage (V_{E}) of an E-field propagated by the coil layer and the electric charge (QE) of the E-field. C_{F} then may be further defined as:

$${C}_{F} = \frac{{Q}_{E}}{{V}_{E}} ,$$

where Q_{E} is an electric charge of the E-field emitted by the antenna at a given point in space and at that point in space

$${Q}_{E} = \frac{{ϕ}_{E}}{{ε}_{0}}$$

where φ_{E} is the electric flux at a given point and co is a constant for the permittivity of free space, then the electric flux (φ_{E}) for the E-field at the given point proximate to the antenna may be utilized in configuring C_{F}, such that, for a given point,

$${C}_{F} = \frac{{ϕ}_{E}}{{V}_{E} * {ε}_{0}} .$$

These values may be summed for a given area of a plurality of such points proximate to the antenna. Thus, positioning of the conductive materials for the filter layer to account for electric flux and optimize C_{F} accordingly may rely on the relationships between the aforementioned, flux-related electrical characteristics.

Accordingly, design of the filter layer may comprise utilizing the shape of the conductor (thus, affecting A) and the amount of conductor used in the filter layer to optimize for the aforementioned performance characteristics, while achieving the necessary value for C_{F}. As will be discussed in more detail below, shape of the filter layer may comprise any of various shapes with design logic dictating the specific forms of the shapes based on the specific performance characteristics that are in mind for a given design for a filter layer. The filter layer's shape may include various shapes and/or features, such as, but not limited to, traces, tines, comb-like structures, coil-mirroring features, etc

The quantity (e.g., amount of area, thickness, etc.) of conductor used for the filter layer may have a direct relationship on the value of C_{F} (e.g., the more conductor used for the filter layer, greater C_{F} will be). Accordingly, more conductor may capture more emissions, but will have a trade-off as this may also raise the ESR of the system due to increased capacitance. Thus, design considerations for ESR, when raising C_{F}, must be considered.

The quantity of conductor used in the filter layer may further be configured for a thickness of the conductor utilized for the filter layer. In some examples, the filter layer may be desired to have a thickness of the conductor that is as thin as possible to maintain a given value for C_{F} that allows for specific performance characteristics, desired for a design, to be optimized. For example, minimizing thickness of the conductor of the filter layer may result in a minimal skin effect for the filter layer. Specifically, the thickness of the filter layer can be a fraction of the skin depth of coil layer (e.g., 10% of skin depth of the coil).

Generally, skin effect is the tendency of an AC current to distribute itself within a conductor such that the current density is more predominant near the surface of the conductor with the remaining conductor body “unused” relative to electrical current flow. The remaining conductor body is “unused” relative to electrical current flow because the current density typically decays with distance therewithin away from the surface of the conductor. The electric current flows mostly near the surface and is referred to as the “skin” of the conductor. The depth at which current flows from the surface is referred to as the “skin depth.” The skin depth then defines the electrical signal conducting path that is active in transmission and/or communication, while the conductor is defined as the body that is capable of conducting an electrical signal.

By utilizing a minimally thin thickness for the filter layer, various benefits are achieved. As mentioned above, having less thickness provides more resistance at the filter layer which may prevent losses from the field that would otherwise be captured by a receiver antenna. Further still, a minimally thin thickness for the filter layer may provide cost benefits, as less conductor means less cost in a bill of materials for the system. Additionally, by having a minimally thin thickness for the filter layer, the antenna itself may be in a more compact form and thus provide spatial benefits when designing the system.

In some examples (e.g., a transmitting antenna with a filter layer), the filter layer may be configured to mitigate emissions (e.g., EMI, noise, etc.) that resonate at a given frequency range (e.g., frequencies under 100 MHz). In such examples, the emissions may primarily be generated by an amplifier of a transmission system within which the transmitting antenna with the filter layer is used. In some other examples (e.g., a receiving antenna with a filter layer), the filter layer may be configured to mitigate emissions (e.g., EMI, noise, etc.) that resonate at a different frequency range (e.g., frequencies greater than 100 MHz). In such examples, the emissions may primarily be generated by a rectifier of a receiver system within which the receiver antenna with the filter layer is used. These characteristics may be configured for a specific operating frequency across a wireless power transfer system (e.g., an operating frequency of about 13.56 MHz).

Turning now to FIG. 9A, an example stack-up 901 is shown that illustrates layers of an antenna 900A for wireless power transmission and/or receipt (e.g., as the wireless transmission antenna 121 and/or the wireless receiver antenna 131). As illustrated, the antenna 900A may comprise a coil layer 910A (represented by the hatched layer of the stack-up 901) and a filter layer 920A (represented by the solid, white layer of the stack-up 901). An arrangement of the coil layer 910A and the filter layer 920A in accordance with the stack-up 901 may be formed as, for example, a multi-layered PCB, manufactured in accordance with PCB manufacturing techniques known in art. However, the antenna 900A arranged in accordance with the stack-up 901 may take any of various other forms.

While not illustrated, an insulator layer may be positioned between the filter layer 920A and the coil layer 910A. The insulator layer may be of any dielectric material that prevents a wired electrical connection between the respective conductive materials of the filter layer 920A and the coil layer 910A.

The stack-up 901 may position the filter layer 920A in close proximity to the coil layer 910A, such that the filter layer 920A is close enough to the coil layer 910A (with an insulator therebetween) that it can capture unwanted emissions (e.g., E-field emissions, conducted emissions, EMI, etc.) and route these emissions to ground, rather than allowing them to propagate to one or more of (i) the general atmosphere as a radiated emission through the air, (ii) as a conducted emission that travels through other components of the respective system(s) (e.g., a wireless transmission system 120, a wireless receiver system 150, etc.), (iii) or combinations thereof. Accordingly, electrically, a node (e.g., a pin, a via, etc.) of the filter layer 920A may be connected to a ground of the respective system (e.g., a wireless transmission system 120, a wireless receiver system 150, etc.), within which the antenna 900A is used.

To that end, as illustrated, the filter layer 920A may be connected to ground (e.g., a chasis ground, a digital ground, etc.) of the respective system via such a node (e.g., as indicated by the node labelled “GND,” which is an abbreviation representative of “ground”). Further, as illustrated, input nodes for the antenna 900A are illustrated (e.g., the nodes labelled “C+” and “C−,” indicating positive and negative ends of the coil layer 910A). Thus, the antenna 900A may be constructed as a three-input (e.g., three-node, three-pin, etc.) antenna, with one of these inputs being a path for emissions captured by the filter layer 920A to be routed to ground (rather than being undesirably routed to another reference ground plane).

Further, as illustrated, the filter layer 920A may have a filter thickness (“t_{F}”) and the coil layer 910A may have a coil thickness (“t_{C}”). In an example, tr may be less than t_{C}. Further, tr may be configured such that t_{F} is a minimally thin thickness for the filter layer 920A, as discussed above.

The stack-up 901 is just one of various forms that a stack-up for an antenna having a filter layer may take.

Turning now to FIGS. 9B-9D, various overhead views of an antenna 900B are illustrated. The antenna 900B is configured for wireless power transmission and/or receipt (e.g., as the wireless transmission antenna 121 and/or the wireless receiver antenna 131). As illustrated, FIG. 9B shows a first overhead view of the antenna 900B, with a coil layer 910B (illustrated with a hatched pattern) overlain by a filter layer 920B (illustrated with solid black lines). FIG. 9C shows a second overhead view of the antenna 900B that highlights the filter layer 920B (with the coil layer 910B not shown). FIG. 9D shows a third overhead view of the antenna 900B that highlights the coil layer 910B (with the filter layer 920B not shown).

From a stack-up perspective, the filter layer 920B may be positioned, with respect to the coil layer 910B, in any of various ways (e.g., the filter layer 920B positioned on top of the coil layer 910B (with an insulator layer therebetween), the filter layer 920B positioned behind the coil layer 910A (with an insulator layer therebetween), etc.). In some examples, the coil layer 910B, the filter layer 920B, and any insulator layers therebetween may combine to comprise a PCB 930B.

As illustrated best in FIG. 9D, the coil layer 910B may comprise (i) coil ends 912B that terminate at poles indicated as “C+” and “C−,” (ii) one or more turns 914B, one or more crossovers 916B, among other features. A current flow through the coil layer 910B may begin at the pole C+ and terminate at the pole C−, flowing through each of the turns 914B.

The turns 914B may take any of various forms. For example and as illustrated, a first outer turn of the turns 914B may extend from each of coil ends 912B, either extending in a vertical or a horizontal direction. In some examples, a turn 914B may extend into another turn 914B inward of itself at the crossovers 916B. In some examples, the innermost turn 914B may be a single loop that terminates at a crossover 916B. The turns 914B may take any of various other forms, as well.

While illustrated as having a single coil layer 910B, it is certainly contemplated that the antenna 900B may comprise a plurality of coil layers 910B. For example, the antenna 900B may comprise a multi-layer multi-turn coil having a plurality of coil layers. Examples of multi-layer multi-turn coils are described in U.S. Pat. No. 11,336,003, entitled “Multi-layer, multi-turn inductor structure for wireless transfer of power,” which is owned by applicant and is herein incorporated by reference in its entirety.

The coil layer(s) 910B may take various other forms, as well.

The filter layer 920B, as best illustrated in FIG. 9C, may comprise a plurality of partial turns 922B, which may resemble a similar shape to the turns 914B (e.g., with respect to their directionality, not thickness); however, the turns do not terminate and continuously connect and, thereby, cause current to flow from one partial turn 922B to another. In contrast, the partial turns 922B may terminate to form tines 924B at one end and terminate at a filter end 926B, at the other end, which is then connected to a ground of the system. The tines 924B terminate independent of one another and, at this point, are not connected to another partial turn 922B. By including partial turns 922 (rather than turns) any current flow that may be induced on the filter layer 920B (e.g., via receipt of a power signal) may avoid signal degradation via eddy currents, as the flow of any such current will not be in opposition to the magnetic power signal that induced the current flow.

As illustrated, the partial turns 922B may be positioned, in a stack-up sense, proximate to the turns 914B of the coil layer 910A. By positioning the partial turns 922 proximate to the turns 914B, the partial turns 922B may be positioned as close as possible to E-fields emanating from the turns 914B and, thus, may be positioned to maximize receipt of said E-fields. This positioning and the resultant receipt of E-fields via the partial turns 922B may lead to greater capture of EMI (e.g., common mode noise) emanating from the coil layer 910B. Then, via a filter end 926B connected to a ground node GND, the filter layer 920B may route the EMI emanating from the coil layer 910B to ground.

The partial turns 922B may take any of various forms. For example, and as illustrated, a first outer turn of the partial turns 922B may extend in two directions from the filter end 926B and extend in a form that mirrors the directionality of an outer turn of the turns 914B (e.g., extension in a vertical or horizontal direction, curving similarly, etc.). In some examples, two separate extending ends of a partial turn 922B may terminate at two separate tines 924B. Furth still, in some examples, the location of the tines 924B may be proximate, in a stack-up sense, to the start/finish of a crossover 916B. The partial turns 922B may take various other forms, as well.

Turning now to FIGS. 9E-9G, various overhead views of an antenna 900E are illustrated. The antenna 900E is configured for wireless power transmission and/or receipt (e.g., as the wireless transmission antenna 121 and/or the wireless receiver antenna 131). As illustrated, FIG. 9E shows a first overhead view of the antenna 900E, with a coil layer 910E (illustrated with a hatched pattern) overlain by a filter layer 920E (illustrated with solid black lines). FIG. 9F shows a second overhead view of the antenna 900E that highlights the filter layer 920E (with the coil layer 910E not shown). FIG. 9G shows a third overhead view of the antenna 900E that highlights the coil layer 910E (with the filter layer 920E not shown).

From a stack-up perspective, the filter layer 920E may be positioned, with respect to the coil layer 910E, in any of various ways (e.g., the filter layer 920E positioned on top of the coil layer 910E (with an insulator layer therebetween), the filter layer 920E positioned behind the coil layer 910E (with an insulator layer therebetween), etc.). In some examples, the coil layer 910E, the insulator layer 920E, and any insulator layers therebetween may combine to comprise a PCB 930E.

As illustrated, the coil layer 910E may comprise (i) coil ends 912E that terminate at poles indicated as “C+” and “C−,” (ii) one or more turns 914E, one or more crossovers 916E, among other features. A current flow through the coil layer 910E may begin at the pole C+ and terminate at the pole C−, flowing through each of the turns 914E.

The turns 914E may take any of various forms. For example and as illustrated, a first outer turn of the turns 914E may extend from each of coil ends 912E, either extending in a vertical or a horizontal direction. In some examples, a turn 914E may extend into another turn 914E inward of itself at the crossovers 916E. In some examples, the innermost turn 914B may be a single loop that terminates at a crossover 916E. The turns 914E may take any of various other forms, as well.

While illustrated as having a single coil layer 910E, it is certainly contemplated that the antenna 900B may comprise a plurality of coil layers 910E. For example, the antenna 900B may comprise a multi-layer multi-turn coil having a plurality of coil layers.

The coil layer(s) 910E may take various other forms, as well.

The filter layer 920E, as illustrated, may comprise (i) a first set of tines 921 positioned proximate to, in a stack-up sense, a first portion 911 (e.g., a left portion) of the coil layer 910E, (ii) a second set of tines 923 positioned proximate to, in a stack-up sense, a second portion 913 (e.g., a right portion) of the coil layer 910E, and, optionally, (iii) teeth 925 positioned proximate to, in a stack-up sense, crossovers 916E of the coil layer 910E. At least some of the tines 921, 923 may extend inward from an outer partial turn 927, which may resemble a similar shape to one of the turns 914E (e.g., with respect to their directionality, not thickness); however, the outer partial turn 927 terminates at ends of the tines 921, 923 and at a filter end 926E. The tines 921, 923 do not electrically connect with one another at their ends, but may electrically connect via the outer partial turn 927.

The outer partial turn 927 may take any of various forms. For example, and as illustrated, the outer partial turn 927 may extend in two directions from the filter end 926E and extend in a form that mirrors the directionality of an outer turn of the turns 914E (e.g., extension in a lateral or horizontal direction, curving similarly, etc.). In some examples, two separate extending ends of the outer partial turn 927 may terminate at two separate tines 921, 923. Furth still, in some examples, the location of these tines 921, 923 may be proximate, in a stack-up sense, to the start/finish of a crossover 916B. Even further, in some examples these tines 921, 923 may terminate to form a portion of teeth 925 that are proximate, in a stack-up sense, to a crossover 916E. The outer partial turn 927 may take various other forms, as well.

Further, the tines 921, 923 and the teeth 925 may take any of various forms. For example, the tines may be configured to extend horizontally inward from (as illustrated) vertically positioned portions of the outer partial turn 927. In some examples, this horizontal extension of each of a set of the tines 921, 923 will terminate to collectively form a hole 935 in the filter layer 920E, wherein conductive material is not present. In some examples, portions of each of a plurality of tines 921, 923 may extend perpendicular to its horizontal extension to combine with other such perpendicular extensions of other tines 921, 923 to form the teeth 925 in one or more areas of the filter layer 920E. These perpendicular extensions, forming teeth 925, may be positioned proximate, in a stack-up sense, to crossovers 916E of the coil layer 910E. The tines 921, 923 and/or the teeth 925 may take various other forms, as well.

By including tines 921, 923 and the outer partial turn 927 (rather than turns) any current flow that may be induced on the filter layer 920B (e.g., via receipt of a power signal) may avoid signal degradation via eddy currents, as the flow of any such current will not be in opposition to the signal that induced the current flow.

Further still, the tines 921, 923 may be configured such that they (i) are positioned, in a stack-up sense, proximate to the turns 914E of the coil layer 910E and (ii) define the hole 935 proximate, in a stack-up sense, to an area 937 in the coil layer 910E wherein little or no conductive material is present. By positioning tines 921, 923 proximate to the turns 914B, the tines 921, 923 may be positioned as close as possible to E-fields emanating from the turns 914B and, thus, may be positioned to maximize receipt of said E-fields. This positioning and the resultant receipt of E-fields via the partial turns 922B may lead to greater capture of EMI (e.g., common mode noise) emanating from the coil layer 910B. Then, via a coil end 926 connected to a ground node GND, the filter layer 920B may route the EMI emanating from the coil layer 910B to ground.

Additionally, the lateral positioning of the tines 921, 923 may be configured to absorb the E-Field in a manner that allows for magnetic field to propagate through to another antenna, while minimizing the electric flux caused by the E-fields emitted by the antenna 900E (or another transmitting antenna), within a given area.

Further still, positioning of conductive materials (e.g., the tines 921, 923) for the filter layer 920E may be specifically configured to have greater density of conductive materials proximate, in a stack-up sense, to areas of the coil layer 910E that will emit greater E-fields when the coil layer 910E is operable to transmit wireless power signals. But still, conductive structures of the filter layer 920E are positioned and configured in a way to also mitigate eddy currents (e.g., by terminating as tines 921, 923 rather than extending as a row or into a turn).

Turning now to FIGS. 9H-J, stack-ups for antennas comprising multiple coil layers and a filter layer are shown. These stack-ups, for example, may be utilized with the coil layers are configured in a multi-layer multi-turn configuration. In such examples, each of the coil layers may be connected to common positive and negative nodes and, thus, the coil layers may be in an electrical parallel configuration, with respect to one another.

Turning now to FIG. 9H, an example stack-up 902 is shown that illustrates layers of an antenna 900H for wireless power transmission and/or receipt (e.g., as the wireless transmission antenna 121 and/or the wireless receiver antenna 131). As illustrated, the antenna 900H may comprise a coil 910H having coil layers 912H (represented by the hatched layer of the stack-up 902) and a filter layer 920H (represented by the solid, white layer of the stack-up 902). As illustrated, the filter layer 920H may be positioned, in a stack-up sense, on top of (or in front of) the coil layers 912H.

In another example, FIG. 9I shows an example stack-up 903 of layers of an antenna 900I for wireless power transmission and/or receipt (e.g., as the wireless transmission antenna 121 and/or the wireless receiver antenna 131). As illustrated, the antenna 900I may comprise a coil 910I having coil layers 912I (represented by the hatched layer of the stack-up 903) and a filter layer 920I (represented by the solid, white layer of the stack-up 902). As illustrated, the filter layer 920I may be positioned, in a stack-up sense, in between coil layers 912I.

In yet another example, FIG. 9J shows an example stack-up 904 of layers of an antenna 900J for wireless power transmission and/or receipt (e.g., as the wireless transmission antenna 121 and/or the wireless receiver antenna 131). As illustrated, the antenna 900J may comprise a coil 910J having coil layers 912J (represented by the hatched layer of the stack-up 904) and a filter layer 920J (represented by the solid, white layer of the stack-up 904). As illustrated, the filter layer 920J may be positioned, in a stack-up sense, on top of (or in front of) the coil layers 912J.

An arrangement of the each of the coil layers 912H, 912I, 912J and the respective filter layers 920H, 920I, 920J in accordance with the stack-ups 902, 903, 904 may be formed as, for example, a multi-layered PCB, manufactured in accordance with PCB manufacturing techniques known in art. However, the antennas 900H, 900I, 900J arranged in accordance with the stack-ups 902, 903, 904 may take any of various other forms.

While not illustrated in FIGS. 9H-9J, an insulator layer may be positioned, respectively, between the filter layers 920H, 920I, 920J and the coil layers 912H, 912I, 912J (and possibly between coil layers 912H, 912I, 912J themselves). The insulator layer may be of any dielectric material that prevents a wired electrical connection between the respective conductive materials of the filter layer 920H, 920I, 920J and the coil layers 912H.

The stack-ups 902, 903, 904 may position the filter layers 920H, 920I, 920J in close proximity to the coil layers 912A, such that the filter layers 920H, 920I, 920J are close enough to the coil layers 912H, 912I, 912J (with an insulator therebetween) that it can capture unwanted emissions (e.g., E-field emissions, conducted emissions, EMI, etc.) and route these emissions to ground, rather than allowing them to propagate to one or more of (i) the general atmosphere as a radiated emission through the air, (ii) as a conducted emission that travels through other components of the respective system(s) (e.g., a wireless transmission system 120, a wireless receiver system 150, etc.), (iii) or combinations thereof. Accordingly, electrically, a node (e.g., a pin, a via, etc.) of the filter layers 920H, 920I, 920J may be connected to a ground of the respective system (e.g., a wireless transmission system 120, a wireless receiver system 150, etc.), within which the antennas 900H, 900I, 900J are used.

To that end, as illustrated, the filter layers 920H, 920I, 920J may be connected to ground (e.g., a chasis ground, a digital ground, etc.) of the respective system via such a node. Further, input nodes for the antennas 900H, 900I, 900J are included to electrically connect the antenna to the respective system. Thus, the antennas 900H, 900I, 900J may be constructed as a three-input (e.g., three-node, three-pin, etc.) antenna, with one of these inputs being a path for emissions captured by the filter layers 920H, 920I, 920J to be routed to ground (rather than being undesirably routed to another reference ground plane).

The stack-ups 902, 903, 904 are a few of various forms that a stack-up for an antenna having a filter layer may take.

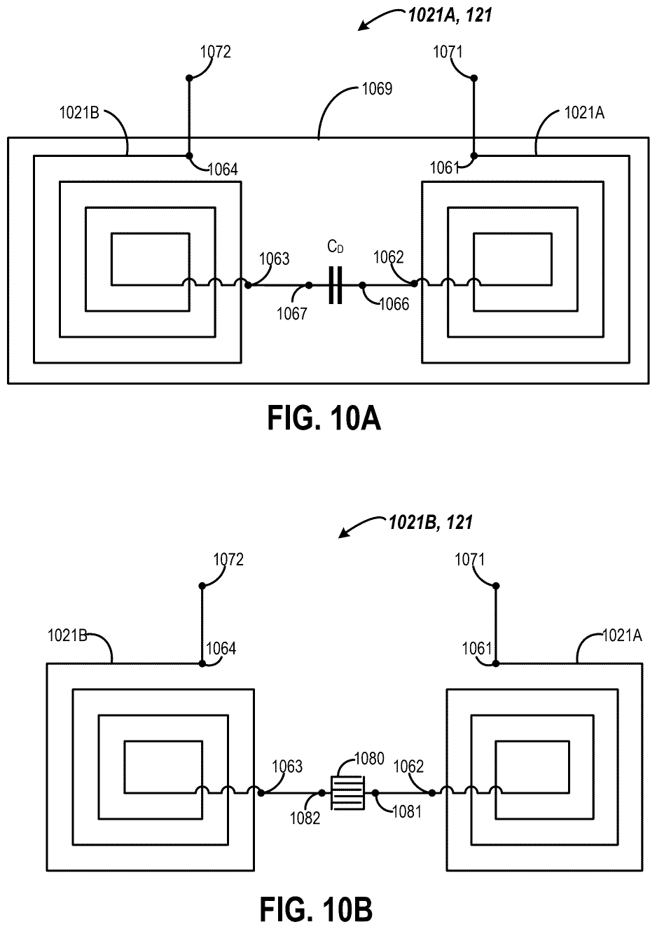

Turning now to FIGS. 10A and 10B, example implementations of respective multi-zone antennas 1021A, 1021B for use as the transmission antenna 121 are illustrated.

As illustrated in FIGS. 10A and 10B and, similarly, in the later illustrated embodiments of the wireless transmission system 120A, the first antenna portion 1025A, which has a first pole 1061 and a second pole 1062. The multi-zone antenna 1021A includes a second antenna portion 1021B which includes a third pole 1063 and a fourth pole 1064. The first and second antenna portions 1021A, 1021B connect to the amplifier 410 via a first power pole 1071 and a second power pole 1072. As illustrated, to achieve the series antenna-to-amplifier connection, the first pole 1061 of the first antenna portion 1021A is in electrical connection with the first power pole 1071, the fourth pole of the second antenna portion 1021B is in electrical connection with the second power pole 1072, and the second pole 1062 of the first antenna portion 1021A is in electrical connection with the third pole 1063 of the second antenna portion 1021B, thereby establishing the series connection between the antenna portions 1021A, 1021B, with respect to the amplifier 410.

FIGS. 10A and 10B illustrate embodiments of the wireless transmission system 120, wherein a distributed capacitor CD is included, in series connection between the first antenna portion 1021A and the second antenna portion 1021B. In such examples, the CD includes a first capacitor pole 1066 and a first capacitor pole 1067. As illustrated, to achieve the series antenna-to-amplifier connection, with CD disposed therebetween, the first pole 1061 of the first antenna portion 1021A is in electrical connection with the first power pole 1071, the fourth pole 1064 of the second antenna portion 1021B is in electrical connection with the second power pole 1072, the second pole 1062 is in electrical connection with the first capacitor pole 1066, and the third pole 1063 is in electrical connection with the first capacitor pole 1067.

By disposing CD in series connection between the first and second antenna portions 1021A, 1021B, transient current spikes and large changes in phase may be mitigated. Such transient current spikes and changes in phase may cause current sensitivity issues, difficulties in manufacturing, and/or coil-to-coil efficiency degradation between multiple antenna portions 1021A, 1021B. Thus, mitigation via inclusion of Cp may be advantageous for improvements in coil sensitivity, mass-manufacturability, and coil-to-coil efficiency. To that end, experimental results have indicated that inclusion of CD causes an increase in coil-to-coil efficiency of about six percent and an impedance shift, due to metal, decreased by about 52 percent. Such increases in efficiency and decreases in impedance shift may be particularly advantageous in transmission antenna 121 designs wherein a, relatively, small transmission antenna 121 has expanded requirements for coupling Z-distance.

Additionally, inclusion of CD, in series connection between the first and second antenna portions 1021A, 1021B, aids in isolating communications for each antenna portion 1021A, 1021B, by limiting interference. For example, if two transmission antenna portions 1021A, 1021B are coupled with two wireless receiver systems CD may prevent interference in communications signals that are transmitted by the wireless receiver systems, via communications within the frequency band of the operating frequency of one or both of the antenna portions 1021B.

Referring specifically to FIG. 10A, a first multi-zone antenna 1021A illustrates CD as implemented as a component on a printed circuit board (PCB) 1069, upon which one or both of the first and second antenna portions 1021A, 1021B are disposed. By utilizing the PCB 1069 having CD thereon, ease in bill of materials may be improved. Further, in such examples, both of the first and second antenna portions 1021A, 1021B may be printed on the same substrate of the PCB 1069 and the receiver first and second antenna portions 1021A, 1021B may be, therefore, internally connected to each other through CD, wherein, in such examples, CD is a surface mount capacitor on the PCB 1069. In comparison to other designs, this configuration may reduce antenna complexity by reducing the number of connections to the amplifier 410, which simplifies the manufacture of the antenna portions 1021A, 1021B. Accordingly, in such examples, the antenna portions 1021A, 1021B and CD are all functionally coupled with the PCB 1069.

Referring again to the PCB 1069, it will be understood to those skilled in the art that PCB 1069 may be a single layer or multi-layer. A multi-layer PCB may further comprise surface and embedded circuit traces, and may also include through-hole, surface mount and/or embedded components and or component circuits. Typical PCB substrate materials may include fiberglass, FR4, a ceramic, among others. In some examples the PCB 969 may further be or include a flexible printed circuit board (FPCB).

Referring specifically to FIG. 10B, a second multi-zone antenna 1021B illustrates CD as implemented as an interdigitated capacitor 1080 in electrical connection with the first antenna portion 1021A and the second antenna portion 1021B. The interdigitated capacitor 1080 includes, at least, a first capacitor pole 1081 and a second capacitor pole 1082. As illustrated, the first pole 1061 of the first antenna portion 1021A is in electrical connection with the first power pole 1071, the fourth pole 1064 of the second portion 1021B is in electrical connection with the second power pole 1072, the second pole of the first antenna portion 1021A is in electrical connection with the first capacitor pole 1081 of the interdigitated capacitor 1080, and the third pole 1063 of the second antenna portion 1021B is in electrical connection with the second capacitor pole 1082 of the interdigitated capacitor 1080.

The interdigitated capacitor 1080 may be included to impart a desired capacitance to one or both of the transmission first and second antenna portions 1021A, 1021B. The interdigitated capacitor 1080 may utilize a parallel plate configuration that can provide a robust, thin design that is, generally, manufacturable at a lower cost, when compared to similar capacitor components. The interdigitated capacitor 1080 has a finger-like shape, wherein the interdigitated capacitor 1080 includes a plurality of micro-strip lines that may produce one or more of high pass characteristics, low pass characteristics, and/or bandpass characteristics. The value of the capacitance of the interdigitated capacitor 1080 generally depends on various construction parameters, such as, but not limited to, a length of the micro-strip lines, a width of the micro-strip line, a horizontal gap between two adjacent micro-strip lines, and a vertical cap between two adjacent micro strip lines. In one or more embodiments, the length and the width of the micro-strip lines can be from about 10 mm to 600 mm, the horizontal gap can be between about 0.1 mm to about 100 mm, and the vertical gap can be between about 0.0001 mm to about 2 mm.

In some examples, the interdigitated capacitor 1080 may be integrated within a substrate associated with one or both of the transmission first and second antenna portions 1021A, 1021B, such as a PCB. Further, in some examples, the interdigitated capacitor 1080 may be positioned within an opening or cavity within a substrate that supports one or both of the transmission first and second antenna portions 1021A, 1021B. The interdigitated capacitor 1080 may be used similarly to CD, for improvements in coil sensitivity, mass-manufacturability, and coil-to-coil efficiency. Additionally or alternatively, the interdigitated capacitor 1080 may be utilized as a cost-effective means to add capacitance to one or both of the transmission first and second antenna portions 1021A, 1021B. Further, the interdigitated capacitor 1080 may be more mechanically durable, have a thinner form factor, and a lower cost, in comparison to a surface mount capacitor.

Further description and examples of such multi-zone type antennas are further disclosed in U.S. Pat. No. 11,101,848 to Peralta, et. al., and entitled “Wireless Power Transmission System Utilizing Multiple Transmission Antennas with Common Electronics,” which is commonly owned by applicant and incorporated by reference herein in its entirety.

While illustrated as individual blocks and/or components of the wireless transmission system 120, one or more of the components of the wireless transmission system 120 may combined and/or integrated with one another as an integrated circuit (IC), a system-on-a-chip (SoC), among other contemplated integrated components. To that end, one or more of the transmission control system 200, the power conditioning system 600, the sensing system 300, the transmission antenna 121, and/or any combinations thereof may be combined as integrated components for one or more of the wireless transmission system 120, the wireless power transfer system 100, and components thereof. Further, any operations, components, and/or functions discussed with respect to the wireless transmission system 120 and/or components thereof may be functionally embodied by hardware, software, and/or firmware of the wireless transmission system 120.

Similarly, while illustrated as individual blocks and/or components of the wireless receiver system 150, one or more of the components of the wireless receiver system 150 may combined and/or integrated with one another as an IC, a SoC, among other contemplated integrated components. To that end, one or more of the components of the wireless receiver system 150 and/or any combinations thereof may be combined as integrated components for one or more of the wireless receiver system 150, the wireless power transfer system 100, and components thereof. Further, any operations, components, and/or functions discussed with respect to the wireless receiver system 150 and/or components thereof may be functionally embodied by hardware, software, and/or firmware of the wireless receiver system 150.

Further still, functionality disclosed herein for carrying out any of the systems and methods disclosed herein may be executed as software. For example, one or more controllers (e.g., the transmission controller 210, the receiver controller 710, etc.) may carry out said functionality of the systems and methods disclosed herein. To that end, any controller disclosed herein includes at least one processor and any controller disclosed herein includes or is otherwise associated with at least one machine-readable medium (e.g., the memory 212, the memory 712, etc.). Said machine-readable medium may comprise program instructions which, when executed by the at least one process of said controller, cause the controller to carry out some functionality disclosed that is associated with the disclosed systems and methods.

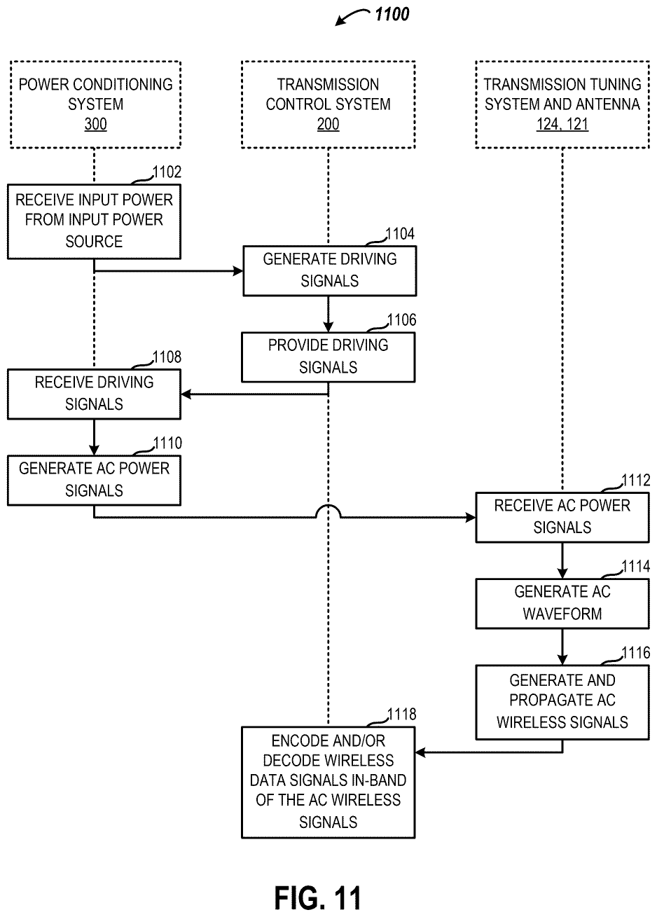

Turning now to FIG. 11, an example method 1100 of operating a wireless transmission system (e.g., the wireless transmission system 120) is illustrated. As illustrated, certain functions of the method 1100 are indicated as being performed by one of the power conditioning system 400, the transmission control system 200, or the transmission tuning system 124 and antenna 121, as indicated by the dotted lines connecting blocks to said components; however, the method 1100 is not limited to having the indicated steps specifically performed by only the indicated connected component. One or more functions of the method 1100 may be carried out by additional or alternative components, as known by those having skill in the art. The functionality discussed below may be carried out using any of the disclosed technology discussed above.

The method 1102 begins with the wireless transmission system 120 receiving input power from an input power source. Then, as indicated by block 1104, the input power may be utilized in generating driving signals for the wireless transmission system 120. In some examples, as indicated in block 1106, the driving signals may be provided to the power conditioning system 400, by the transmission control system 200.

The driving signals may be received by the power conditioning system 400 and utilized to generate AC power signals (block 1110), which, in some examples, are received by the transmission tuning system 124 and antenna 121 (block 1112). Then, based on the driving signals, the wireless transmission system 120 generates an AC waveform based on the driving signals (block 1114) to then generate and propagate AC wireless signals based on said waveform (block 1116). In some examples, the wireless transmission system 120 may optionally encode and/or decode data signals in-band of the propagated AC wireless signals, in accordance with the technology disclosed above.

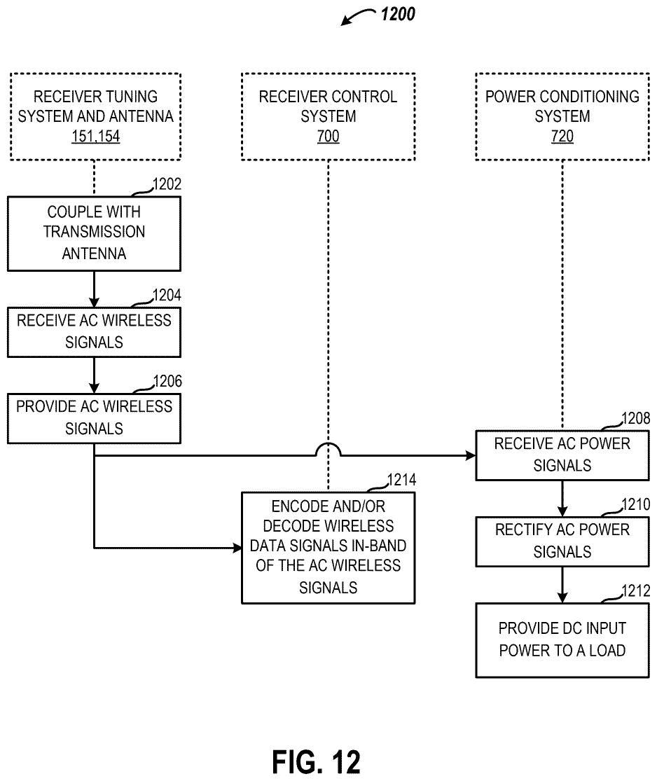

Turning now to FIG. 12, an example method 1200 of operating a wireless receiver system (e.g., the wireless transmission system 120) is illustrated. As illustrated, certain functions of the method 1200 are indicated as being performed by one of the power conditioning system 720, the receiver control system 700, or the receiver tuning system 154 and antenna 151, as indicated by the dotted lines connecting blocks to said components; however, the method 1200 is not limited to having the indicated steps specifically performed by only the indicated connected component. One or more functions of the method 1200 may be carried out by additional or alternative components, as known by those having skill in the art. The functionality discussed below may be carried out using any of the disclosed technology discussed above.

The method 1200 begins when the wireless receiver system 150 couples with a wireless transmission system (e.g., the wireless transmission system 120), via NFMI, as illustrated in block 1202. Then, the wireless receiver system 150 may receive AC wireless signals, such as wireless power signals, as illustrated in block 1204.

The antenna 151 and/or the receiver tuning system 154 may provide the AC wireless signals (block 1206) to the power conditioning system, which receives that AC wireless signals (block 1208). The wireless receiver system 150 may then rectify the AC wireless signals to generate DC output power (block 1210) to then, for example, provide meaningful electrical power to a load associated with the wireless receiver system 150 (block 1212). In some examples, the wireless receiver system 150 may optionally encode and/or decode data signals in-band of the received AC wireless signals, in accordance with the technology disclosed above.

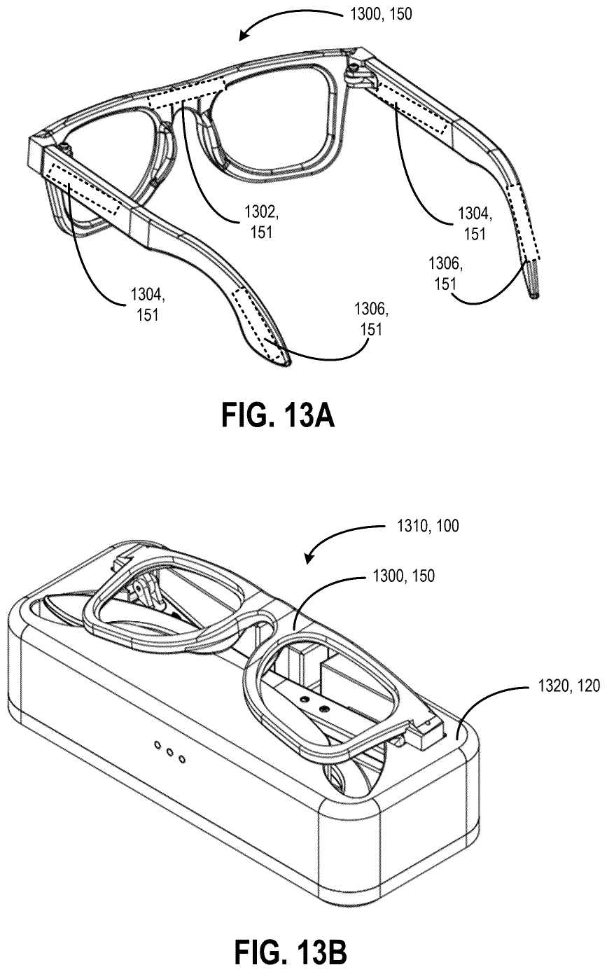

Example devices that may utilize the disclosed wireless power transfer technology are illustrated in FIGS. 13A-16B. Each of the example devices of FIGS. 13A-16B may include or otherwise be operatively associated with a wireless receiver system 150 or a wireless transmission system 120.

FIG. 13A is an exemplary illustration of eyewear 1300, in which the wireless receiver system 150 and/or any components thereof may be integrated within the eyewear 1300, such that electronic components within and/or associated with the eyewear can receive power from a wireless transmission system 120, via the wireless receiver system 150. Eyewear may be any face-wearable accessory and/or device that covers, at least in part, at least one eye of a user. Eyewear may include, but is not limited to including, eyeglasses, prescription eyeglasses, reading glasses, fashion glasses, electronic glasses, sunglasses, smart glasses with integrated electronics, hearing aid glasses, speaker enabled glasses, altered reality (AR) glasses, virtual reality (VR) glasses, glasses with screens and/or projectors within or associated with lenses, among other contemplated eyewear. The wireless receiver system 150 integrated with the eyewear 1800 may be utilized to charge a battery or other storage device of or associated with the eyewear and/or the wireless receiver system 150 may be configured to directly power one or more components of or associated with the eyewear 1800.

FIG. 13B illustrates the eyewear 1300 of FIG. 13B combining with a receptacle 1320, which includes the wireless transmission system 120 integrated and/or operatively associated with the receptacle 1320. The eyewear 1300 and the receptacle 1320 combine as an electronic eyewear system 1310, which integrates the wireless power transfer system 100 therein. The receptacle 1320 may be any surface, device, and/or container in which the eyewear 1300 interacts such that the integrated wireless receiver system 150 and integrated wireless transmission system 120 are capable of coupling for wireless power and data transfer. Receptacles 1320 may include, but are not limited to including, cases, pouches, holders, stands, surfaces, among other things. It is to be noted that the form-factors illustrated for the eyewear 1300 and/or the receptacle 1320 are merely exemplary and are not intended to limit the scope of the disclosure; other form factors for eyewear 1300 and/or receptacle(s) 1320 are certainly contemplated.

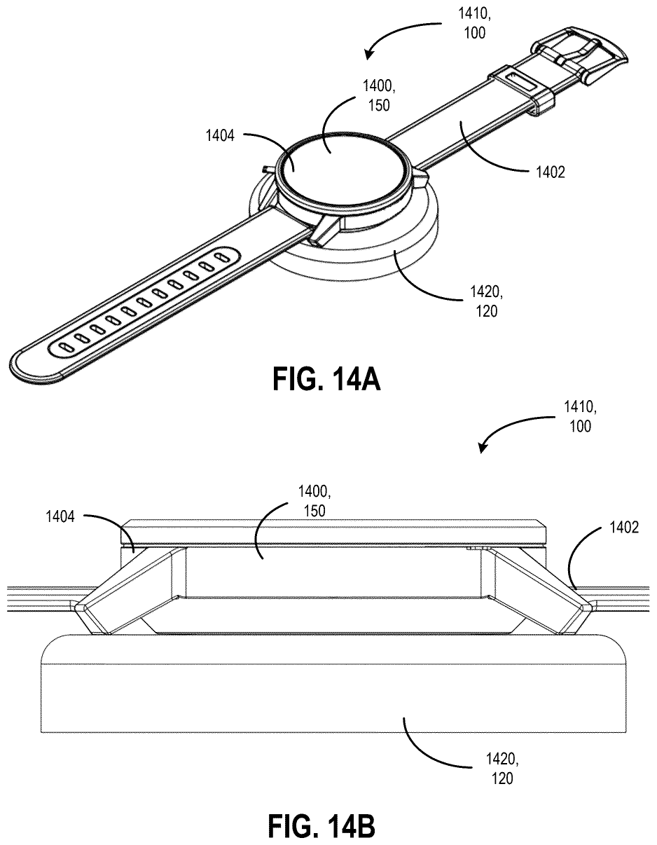

FIGS. 14A and 14B illustrate an example wearable device system 1410, which may incorporate or be operatively associated with the wireless power transfer system 100. FIG. 14A is an isometric view of the wearable device system 1410, when components are operatively in position for wireless power transfer, and FIG. 14B is a side view of the system 1410, in similar positioning. The wearable device system 1410 includes, at least, a wearable device 1400, which includes, is integrated with, and/or is operatively associated with the wireless receiver system 150. As used herein, a “wearable device” refers to any limb-wearable (e.g., wrist-wearable, ankle-wearable, leg-wearable, shoulder-wearable, forearm-wearable, upper-arm wearable, thigh-wearable, calf-wearable, hand-attached, foot-attached, etc.) and/or body wearable (chest-wearable, neck wear-able, waist-wearable, mid-section-wearable, etc.) electronic device that may require and/or benefit from receiving electrical power for some function. In some examples, such a wearable device may include a strap and/or connector (e.g., the strap 1402 of the wearable device 1400) utilized for connecting the wearable device to a user. Exemplary wearable devices include, but are not limited to including, smart watches, watches, fitness trackers, fitness bands, sleep monitors, heart rate monitors, medical devices, ankle monitors, tracking devices, industrial tracking and/or safety devices, identification devices, wearable peripherals for AR systems, wearable peripherals for VR systems, wearable peripherals for gaming consoles and/or platforms, among other wearable devices. The wireless receiver system 150 integrated with the wearable device 1400 may be utilized to charge a battery or other storage device of or associated with the wearable device 1400 and/or the wireless receiver system 150 may be configured to directly power one or more components of or associated with the wearable device 1400.

As illustrated, the wearable device system 1410 further includes a charger 1420, which includes the wireless transmission system 120 integrated with and/or operatively associated with the charger 1420. The charger 1420 may be any surface, device, object, and/or container in which the wearable device 1400 interacts such that the integrated wireless receiver system 150 and integrated wireless transmission system 120 are capable of coupling for wireless power and data transfer. The charger 1420 may be and/or include any surfaces, proprietary devices, multi-device chargers, integrated chargers, cases, stands, holders, receptacles, and/or pouches, among other things. It is to be noted that the form-factors illustrated for the wearable device 1400 and/or the charger 1420 are merely exemplary and are not intended to limit the scope of the disclosure; other form factors for the wearable device 1400 and/or the charger 1420 are certainly contemplated.

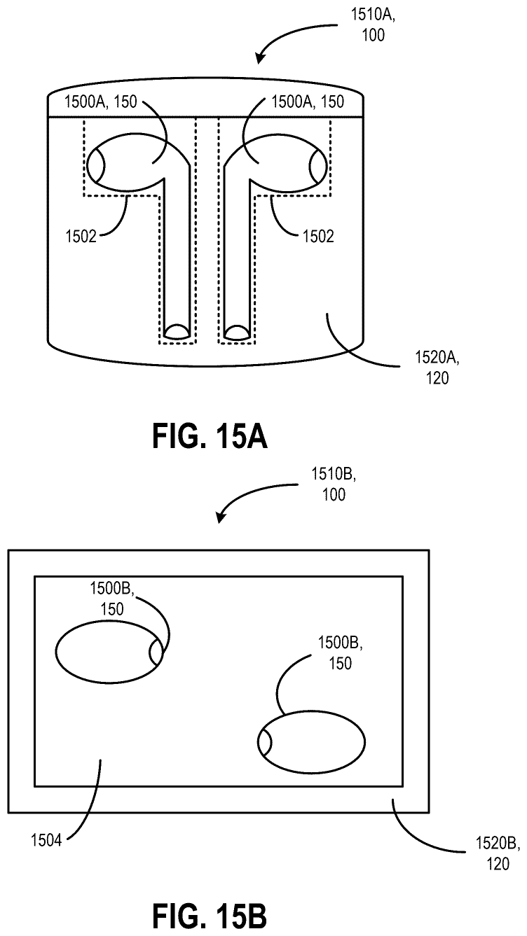

FIG. 15A is a side view of an example listening device system 1510A which may incorporate or be operatively associated with the system 100. The listening device system 1510A includes, at least, one or more listening devices 1500A, which include, are integrated with, and/or are operatively associated with the wireless receiver system 150. As used herein, a “listening device” may include any portable device designed to output sound that can be heard by a user, such as headphones, earbuds, canalphones, over ear headphones, ear-fitting headphones, headsets, digital conferencing headsets, among other listening devices. Headphones are one type of portable listening device, while portable speakers are another. The term “headphones” represents a pair of small, portable listening devices that are designed to be worn on or around a user's head. Such devices convert an electrical signal to a corresponding sound that can be heard by the device. Headphones include traditional headphones that are worn over a user's head and include left and right listening devices connected to each other by a head band, headsets, and earbuds.

Earbuds may be defined as small headphones that are designed to be fitted directly in a user's ear. As used herein, the term “earbuds,” which can also be referred to as ear-phones or ear-fitting headphones, includes both small headphones that fit within a user's outer ear facing the ear canal without being inserted in the ear canal, and in-ear headphones, sometimes referred to as canalphones, that are inserted in the ear canal itself. The wireless receiver system 150 integrated with the listening device(s) 1500 may be utilized to charge a battery or other storage device of or associated with the listening device(s) 1500 and/or the wireless receiver system 150 may be configured to directly power one or more components of or associated with the listening device(s) 1500.

As illustrated, the listening device system 1510A includes a case 1520A, which includes the wireless transmission system 120 integrated and/or operatively associated with the case 1520A. The case 1520 may be any container, receptacle, case, housing, flexible plastic housing, cloth case, leather case, among other things, in which the listening device(s) 1500A may reside, at least in part, in a manner in which the wireless receiver system 150 and the wireless transmission system 120 of the case 1520A are capable of coupling for wireless power and data transfer. In some examples, such as the illustration of FIG. 15A, the case 1520A may define one or more mechanical features 1502, which are configured for aligning the wireless transmission system 120 with the wireless receiver system 150 for proper placement for wireless power transfer.

FIG. 15B is another embodiment of an exemplary listening device system 1510B, wherein listening device(s) 1500B include and/or are operatively associated with the wireless receiver system 150 and a charging surface 1520B is operatively associated with the wireless transmission system 120 and configured for allowing wireless power transfer over the system 100. The listening device(s) 1500B may comprise any of the same types of listening devices described above with reference to the listening device(s) 1500A of FIG. 15A.

The charging surface 1520B may be any surface configured to house the wireless transmission system 120, obfuscate the wireless transmission system 120, indicate presence of the wireless transmission system 120, and/or indicate a charge volume for the listening device(s) 1500B. To that end, the charging surface 1520B may be a surface of a proprietary charger, a surface of a multidevice charger, a surface within a case and/or receptacle for the listening device(s) 1500B, a surface of an electronic device (e.g., a laptop computer, a smartphone, a mobile device, a tablet computer, among other electronic devices), a consumer, private, and/or commercial table and/or countertop, and/or a desktop, among other contemplated surfaces. It is to be noted that the form-factors illustrated for the listening devices 1530A, 1530B, the case 1520A, and the charging surface 1520B are merely exemplary and are not intended to limit the scope of the disclosure; other form factors for the listening devices 1530A, 1530B, the case 1520A, and the charging surface 1520B are certainly contemplated.

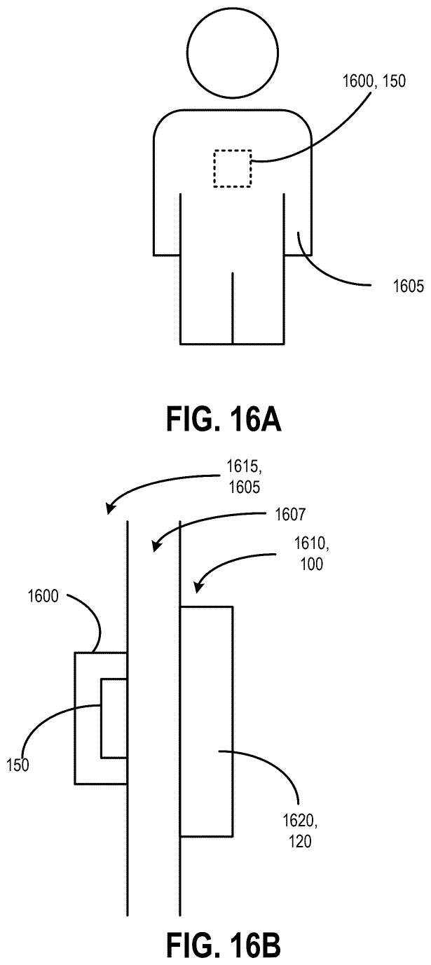

Turning now to FIGS. 16A, an example implantable device 1600, which may include the wireless receiver system 150 and may be implanted within a body 1605, is illustrated in a front, plan-style view. The body 1605 may be any organic being that can have the implantable device 1600 implanted on it or within it, at least in part. The body 1605 may be a human being, an animal (e.g., a pet, a wild animal, a captive animal, etc.), among other known organic bodies.

The implantable device 1600 may be a medical device for a human (e.g., a stimulator, a pacemaker, an insulin pump, a sleep-apnea device, a neurostimulator, etc.), a pet-related implantable device (e.g., a location tracker for a pet, a health monitor for a pet, an identifying marker for a pet, etc.), etc. Further, the implantable device 2100 may take various other forms.

FIG. 16B is a side, cross sectional view of an implantable device system 1610, which utilizes the wireless power transfer system 100 for wireless power transfer to the implantable device 1600. As illustrated, the implantable device system 1610 further includes a charger 1620, which includes the wireless transmission system 120 integrated with and/or operatively associated with the charger 1620. The charger 1620 may be any surface, device, object, and/or container in which the implantable device 1600 interacts such that the integrated wireless receiver system 150 and integrated wireless transmission system 120 are capable of coupling for wireless power transfer. The charger 1620 may be and/or include any surfaces, proprietary devices, multi-device chargers, integrated chargers, cases, stands, holders, receptacles, and/or pouches, among other things. It is to be noted that the form-factors illustrated for the implantable device 1600 and/or the charger 1620 are merely exemplary and are not intended to limit the scope of the disclosure; other form factors for the implantable device 1600 and/or the charger 1620 are certainly contemplated.

As illustrated, the implantable device 1600 may be located within an inner-body volume 1615, which is a volume internal to the body 1605. When the charger 1620 is positioned, relative to the implantable device 1600, the charger 1620 may be positioned proximate to a tissue layer 1607 of the body 1605, which separates the inner-body volume 1615 from the outside world. Thus, the charger 1620 may be configured to charge the implantable device 1600, through the tissue layer 1607.

Implantable devices 1600 utilizing the wireless power transfer system 100 may be quite useful in a variety of fields, as they may prevent the unnecessary removal of implantable devices 1600 from the body 1605 to, for example, replace a battery that is depleted.

With respect to any of the data transmission systems disclosed herein, it should be appreciated that either or both of the wireless power sender and the wireless power receiver may wirelessly send in-band legacy data. Moreover, the systems, methods, and apparatus disclosed herein are designed to operate in an efficient, stable and reliable manner to satisfy a variety of operating and environmental conditions. The systems, methods, and/or apparatus disclosed herein are designed to operate in a wide range of thermal and mechanical stress environments so that data and/or electrical energy is transmitted efficiently and with minimal loss. In addition, the system 10 may be designed with a small form factor using a fabrication technology that allows for scalability, and at a cost that is amenable to developers and adopters. In addition, the systems, methods, and apparatus disclosed herein may be designed to operate over a wide range of frequencies to meet the requirements of a wide range of applications.

In an embodiment, a ferrite shield may be incorporated within the antenna structure to improve antenna performance. Selection of the ferrite shield material may be dependent on the operating frequency as the complex magnetic permeability (μ=u′−j*μ″) is frequency dependent. The material may be a polymer, a sintered flexible ferrite sheet, a rigid shield, or a hybrid shield, wherein the hybrid shield comprises a rigid portion and a flexible portion. Additionally, the magnetic shield may be composed of varying material compositions. Examples of materials may include, but are not limited to, zinc comprising ferrite materials such as manganese-zinc, nickel-zinc, copper-zinc, magnesium-zinc, and combinations thereof.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more embodiments, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

A phrase such as “an aspect” does not imply that such aspect is essential to the subject technology or that such aspect applies to all configurations of the subject technology. A disclosure relating to an aspect may apply to all configurations, or one or more configurations. An aspect may provide one or more examples of the disclosure. A phrase such as an “aspect” may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples of the disclosure. A phrase such an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples of the disclosure. A phrase such as a “configuration” may refer to one or more configurations and vice versa.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include,” “have,” or the like is used in the description or the claims, such term is intended to be inclusive in a manner similar to the term “comprise” as “comprise” is interpreted when employed as a transitional word in a claim. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

Reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub combination or variation of a sub combination. As a further example, it will be appreciated that certain protocols are used as specific example communications schemes herein, other wired and wireless communications techniques may be used where appropriate while embodying the principles of the present disclosure.

We claim:

1. A wireless power transmission system comprising:
a controller configured to generate a driving signal;
a power conditioning system configured to generate a power signal based on the driving signal;
a ground; and
an printed circuit board (PCB) antenna comprising:
at least one coil layer configured to generate a wireless power signal based on the power signal, the coil layer comprising:
one or more turns;
a first coil end; and
a second coil end, wherein the at least one coil layer is electrically connected to the power conditioning system via (i) a positive electrical node connected to the first coil end and (ii) a negative electrical node connected to the second coil end; and
a filter layer positioned in a stack-up with the at least one coil layer, the filter layer comprising:
one or more tines each (i) comprising a conductive material, (ii) positioned proximate to the plurality of turns, and (iii) terminating at one end; and
a filter end that is electrically connected to the ground, wherein the filter layer is configured to (i) absorb an electric field (E-field) emitted by the at least one coil layer when generating the wireless power signal and (ii) route the absorbed E-field to the ground.

2. The wireless power transmission system of claim 1, wherein the filter layer comprises one or more partial turns each (i) comprising a tine of the one or more tines and (ii) terminating at the filter end.

3. The wireless power transmission system of claim 2, wherein the one or more partial turns are each positioned proximate to a respective turn of the one or more turns.

4. The wireless power transmission system of claim 1, wherein the filter layer comprises an outer partial turn that terminates at the filter end and
wherein the one or more tines extend inward from the outer partial turn.

5. The wireless power transmission system of claim 4, wherein the one or more tines each extend laterally from the outer turn and are positioned to overlay the one or more turns.

6. The wireless power transmission system of claim 5, wherein positioning of the one or more tines defines a hole in the filter layer.

7. The wireless power transmission system of claim 4, wherein the coil layer further comprises one or more crossovers and
wherein the filter layer further comprises one or more sets of teeth that are each positioned proximate to one of the one or more crossovers.

8. The wireless power transmission system of claim 1, wherein the at least one coil layer comprises a first coil layer and a second coil layer.

9. The wireless power transmission system of claim 8, wherein the first and second coil layers combine to form a multi-layer multi-turn inductor.

10. The wireless power transmission system of claim 8, wherein the filter layer is positioned between the first coil layer and the second coil layer.

11. A printed circuit board (PCB) antenna for a wireless power transmission system, the PCB antenna comprising:
at least one coil layer configured to generate a wireless power signal based on a power signal, the coil layer comprising:
one or more turns;
a first coil end; and
a second coil end, wherein the at least one coil layer is configured to electrically connect to a power conditioning system via (i) a positive electrical node connected to the first coil end and (ii) a negative electrical node connected to the second coil end; and
a filter layer positioned in a stack-up with the at least one coil layer, the filter layer comprising:
one or more tines each (i) comprising a conductive material, (ii) positioned proximate to the plurality of turns, and (iii) terminating at one end; and
a filter end that is electrically connected to a ground of the wireless transmission system, wherein the filter layer is configured to (i) absorb an electric field (E-field) emitted by the at least one coil layer when generating the wireless power signal and (ii) route the absorbed E-field to the ground.

12. The PCB antenna of claim 11, wherein the filter layer comprises one or more partial turns each (i) comprising a tine of the one or more tines and (ii) terminating at the filter end.

13. The PCB antenna of claim 12, wherein the one or more partial turns are each positioned proximate to a respective turn of the one or more turns.

14. The PCB antenna of claim 11, wherein the filter layer comprises an outer partial turn that terminates at the filter end and
wherein the one or more tines extend inward from the outer partial turn.

15. The PCB antenna of claim 14, wherein the one or more tines each extend laterally from the outer turn and are positioned to overlay the one or more turns.

16. The PCB antenna of claim 15, wherein positioning of the one or more tines defines a hole in the filter layer.

17. The PCB antenna of claim 14, wherein the coil layer further comprises one or more crossovers and
wherein the filter layer further comprises one or more sets of teeth that are each positioned proximate to one of the one or more crossovers.

18. The PCB antenna of claim 11, wherein the at least one coil layer comprises a first coil layer and a second coil layer.

19. The PCB antenna of claim 18, wherein the first and second coil layers combine to form a multi-layer multi-turn inductor.

20. The PCB antenna of claim 18, wherein the filter layer is positioned between the first coil layer and the second coil layer.
